(19) United States
(12) Patent Application Publication
(10) Pub. No.: US 2016/0117638 A1
(43) Pub. Date: Apr. 28, 2016

(54) SYSTEMS AND METHODS FOR DYNAMIC MANAGMENT OF OBJECT TRANSMISSION

(71) Applicant: Aldo DiSorbo, Davie, FL (US)

(72) Inventor: Aldo DiSorbo, Davie, FL (US)

(21) Appl. No.: 14/840,299

(22) Filed: Aug. 31, 2015

Related U.S. Application Data
(60) Provisional application No. 62/059,961, filed on Oct. 5, 2014.

(51) Int. Cl. G06Q 10/08; G06Q 10/06

(52) U.S. Cl. CPC G06Q 10/0833; G06Q 10/06398

(57) ABSTRACT

A system for dynamically managing transport of at least one item from a source location to a destination location, the system configured to: (1) ascertain a mode of the administrator after authenticating an administrator; (2) perform a set of administrative functions; (3) assign a load from the set of accepted loads to the driver; (4) ascertain a set of load attributes for loads requested from a set of external sources; (5) display a job acceptance form to ascertain a set of job attributes; (6) assign at least one driver to a specific load; (7) display and edit the driver's log book; (8) locate the driver and the driver's specific equipment on a map; (9) evaluate the driver's performance by reviewing a set of assignments completed by the driver within a predefined time span; and (10) configure a set of system parameters.

### BACKGROUND

1. Field of Disclosure

The present invention relates to systems and methods for dynamically managing transport of at least one object from a source location to a destination location. More particularly, the invention relates to the use of a single portal for drivers and administrator(s) configured to dynamically manage moves while efficiently allocating resources.

2. Brief Description of Related Art

A moving company (i.e., an entity which transports items belonging to a person or business from one location to another) may typically perform several management functions to conduct a move. For example, a project which includes, but is not necessarily limited to, the transportation of items (e.g., furniture, appliances, belongings and the like) from one or more source locations to one or more destination locations, such as from a residence or business at one location to a residence or business at another location is a time-consuming process. An administrator may typically have to spend a significant amount of time and resources, to coordinate several moves all across the country, and even then may not be able to find a best possible resolution to a pending transportation issue.

Conventional transportation systems do not have a way of dynamically and simultaneously managing transportation in a driver mode and an administrator mode. An administrator using the conventional systems may not be able to identify load or a set of loads situated in vicinity of a driver who may be driving equipment that can easily accommodate the identified load or the set of loads.

Likewise, the conventional transportation systems do not provide a way for ascertaining inventory information, and a special handling instruction, and dynamically assigning a specific load to a specific driver in the real time. For example, to be cost effective, a transport of an ice cream inventory requiring freezer equipment can be combined with the transport of frozen vegetables if the space permits. Similarly, at the moment there is no means for shifting a load contained in malfunctioning equipment to another functional equipment located nearby.

Furthermore, no means exist to evaluate the performance of a driver or a company on the fly before assigning a load requiring special qualifications of the driver. For example, a load from currency carrying truck should not be assigned to a driver with a pending felony charge or history of theft.

Therefore, there is a need in the art for methods and systems for dynamically evaluating driver performances prior to assigning load of interest to a best available driver. It is desirable to have a system that can toggle between a driver mode and an administrative mode, to mitigate the difficulties faced by the conventional transportation systems. It would be advantageous if such a method and system availed a single portal to create and modify load assignments and manage special situations that are frequently encountered in the transportation world such as bad weather and malfunctioning equipment.

### BRIEF SUMMARY

By way of introduction only, the present embodiments provide the use of a single portal for drivers and administrator(s) configured to dynamically manage moves while efficiently allocating resources. The disclosed invention presents methods and systems for dynamically managing transport of at least one item from a source location to a destination location, the method comprising: (1) ascertaining a mode of the administrator after authenticating an administrator; (2) performing a set of administrative functions if the administrator selected an administrative mode, wherein the set of administrative functions comprise: (a) previewing a set of loads board, a set of accepted loads, a set of loads situated in vicinity of a driver, a system alert, and a conversation, wherein the set of loads board may indicate jobs that are available to be serviced; (b) assigning a load from the set of accepted loads to the driver and transmitting the assignment notification to drivers; (c) ascertaining a set of load attributes for loads requested from a set of external sources; (d) viewing a job acceptance form to ascertain a set of job attributes comprising: a job number, an origin location information, a destination location information, a packing instruction, a storage instruction, an inventory information, and a special handling instruction; (e) assigning at least one driver to a specific load after reviewing a set of accepted loads and loads assigned to each driver; (f) viewing the driver's log book for editing at least one of the driver's current log and the driver's past logs; (g) locating the driver and the driver's specific equipment on a map by selecting a location indicator on the map; (h) evaluating the driver's performance by viewing a set of assignments completed by the driver within a predefined time span; and (i) configuring a set of system parameters and generating reports reflecting system performance during a selected time span.

Further, the set of system parameters may comprise a number of licenses granted to the driver's employer company, a number of licenses granted to the driver, a set of company profile parameters for the company, and a set of equipment assigned to the driver. Furthermore, the corresponding set of load attributes comprise a load number, a source location city, a source location state, a source location zip, a destination city location, a destination state location, a destination location zip, a pick up date, a delivery date, a load weight measure, the distance measure between the source location and the destination location, and a load cash on delivery details.

The claimed method may further comprise the step of sorting the requested loads based on at least one of the set of load attributes. Additionally, the claimed method comprises the step of changing a load assignment from a first driver to a second driver. A log book of a selected driver during certain time span may be accessed to perform at least one of the following operations: editing the log book, using a past log book to show a historical trend for audit purposes, ascertaining the impact of a specific trip during a specific time span, and sending log book to a third party compliance observing entity. The claimed method further comprises the step of dynamically scheduling an additional load pickup for the selected driver, wherein the additional load is to be picked up at the location that is en route to the selected driver's previously scheduled assignment location. Likewise, the claimed method may comprise the step of dynamically scheduling an additional load delivery for the selected driver, wherein the additional load is to be delivered at a location that is en route to the selected driver's previously scheduled assignment location. Additionally, the claimed method may comprise dynamically scheduling a partial load delivery for the selected driver, wherein the partial load is to be delivered at a location that is en route to the selected driver's previously scheduled assignment location. Furthermore, the claimed method may dynamically add cargo from malfunctioning equipment located at a first location to the equipment of the selected driver, wherein the first location is en route to the selected driver's previously scheduled assignment location.

The method may further comprise the step of evaluating the performance of the selected driver by interpreting the statistical information associated with the selected driver, wherein the statistical information comprising: a survey score and the claim percentage score of the selected driver. The method may comprise the step of evaluating the performance of a driver by viewing the details pertaining to a set of assignments completed by the driver within a predefined time span, wherein the predefined time span may be at least one of: 30 days, 60 days, and 90 days. Alternatively, the predefined time span may be the entire duration of the driver's service at a company. Furthermore, the method may comprise evaluating a company performance by viewing a set of assignments completed by the company within a predefined time span.

The method may perform a set of driver functions by a driver if the mode is a driver mode, wherein the set of driver functions may comprise: (1) viewing a dashboard displaying a list of loads assigned to the driver, a log book, weather information in the driver's location area, the driver's statistical information and a set of useful links such as locations of the nearby fuel station, hotel, weight station, packing material retailer location etc.; (2) viewing a list of incomplete loads assigned to driver before selecting a job for viewing the load specific information; (3) acknowledging a new job assigned to the driver; (4) accepting the job via a job acceptance form after ascertaining a set of job attributes; (5) getting directions to the selected job destination location and commencing paper work for the selected job; (6) revising the original cost estimation after reviewing at least one of: a move estimation as computed at the time of booking, a furniture list, additional charges, additional services required during the pickup, additional services required during the delivery, and the packing instruction; (7) creating an inventory indicating a list of items to be moved from the source location to the destination location by taking a picture of the actual item and describing a condition of the item; (8) accepting a payment upon transmitting the inventory from the source location to the destination location; (9) Creating an item damage claim if an item is damaged during the transportation; and (10) Creating a missing item claim if the item is lost during the transportation.

Persons skilled in the art may recognize that the present invention may be used with numerous types of transmission systems. For instance, the method or system of the present invention can be deployed on an interactive resource optimization system or modified for use with a conventional telephone network, a cellular network, a wireless network, or a cable network.

These and other objects and advantages of the present invention may become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that may be described hereinafter and which may form the subject matter of the claims appended hereto.

### BRIEF DESCRIPTION OF SEVERAL VIEWS OF THE DRAWINGS

FIG. 1 illustrates a login interface according to one embodiment of the system of the disclosed invention;

FIG. 2 depicts a new administrator registration interface according to one embodiment of the system of the disclosed invention;

FIG. 3 depicts a licensing options interface according to one embodiment of the system of the disclosed invention;

FIG. 4 depicts a payment interface according to one embodiment of the system of the disclosed invention;

FIG. 5 depicts a tractor configuration interface according to one embodiment of the system of the disclosed invention;

FIG. 6 depicts a trailer configuration interface according to one embodiment of the system of the disclosed invention;

FIG. 7 depicts a straight truck configuration interface according to one embodiment of the system of the disclosed invention;

FIG. 8 depicts a summary of equipment configuration interface according to one embodiment of the system of the disclosed invention;

FIG. 9 depicts a driver information configuration interface according to one embodiment of the system of the disclosed invention;

FIG. 10 illustrates a license purchase interface according to one embodiment of the system of the disclosed invention;

FIG. 11 depicts an equipment assignment interface according to one embodiment of the system of the disclosed invention;

FIG. 12 depicts dashboard interface according to one embodiment of the system of the disclosed invention;

FIG. 13 depicts a loads board interface according to one embodiment of the disclosed invention;

FIG. 14 displays accepted loads interface according to one embodiment of the disclosed invention;

FIG. 15 displays job acceptance form interface according to one embodiment of the disclosed invention;

FIG. 16 displays driver's route interface according to one embodiment of the disclosed invention;

FIG. 17 displays job driver's job priority configuration interface according to one embodiment of the disclosed invention;

FIG. 18 displays load assignment modification interface according to one embodiment of the disclosed invention;

FIG. 19 displays an exemplary driver log book search interface according to one embodiment of the disclosed invention;

FIG. 20 displays an exemplary driver log book interface according to one embodiment of the disclosed invention;

FIG. 21 displays a locate driver interface according to one embodiment of the disclosed invention;

FIG. 22 displays completed loads, driver and company stats interface according to one embodiment of the disclosed invention;

FIG. 23 displays settings interface according to one embodiment of the disclosed invention;

FIG. 24 displays an example of the report interface whereby admin may select a driver and a date range to generate a report for the selected driver's activity during the selected date range according to one embodiment of the disclosed invention;

FIG. 25 displays an interface displaying pre and post inspection details according to one embodiment of the disclosed invention;

FIG. 26 displays state miles report interface according to one embodiment of the disclosed invention;

FIG. 27 displays material report interface according to one embodiment of the disclosed invention; and

FIG. 28 displays useful links interface according to one embodiment of the disclosed invention.

### DETAILED DESCRIPTION OF THE PRESENTLY PREFERRED EMBODIMENTS

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. The present invention provides systems, methods and apparatus for efficiently transporting items being shipped or transported from one location to another.

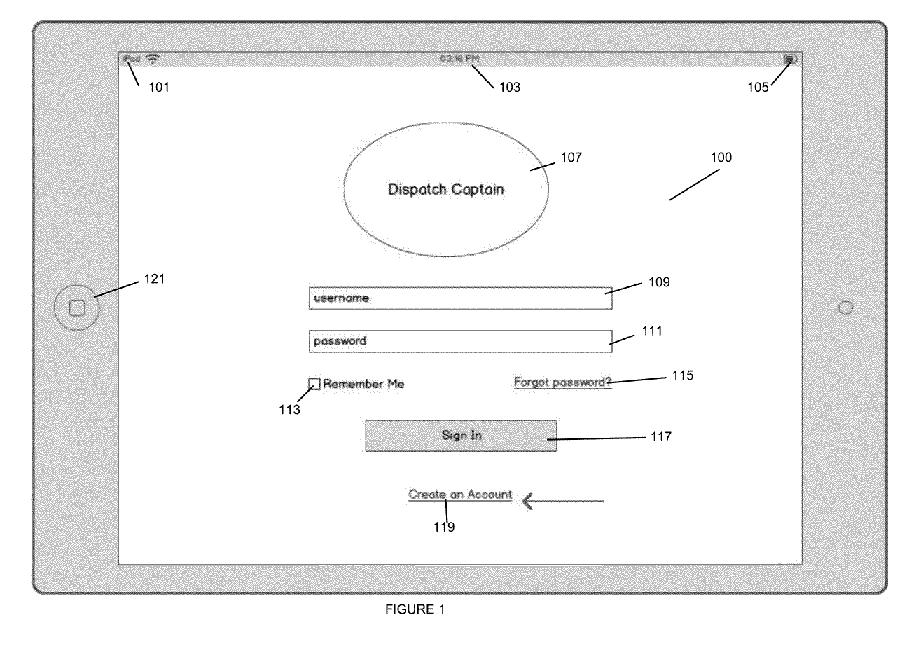

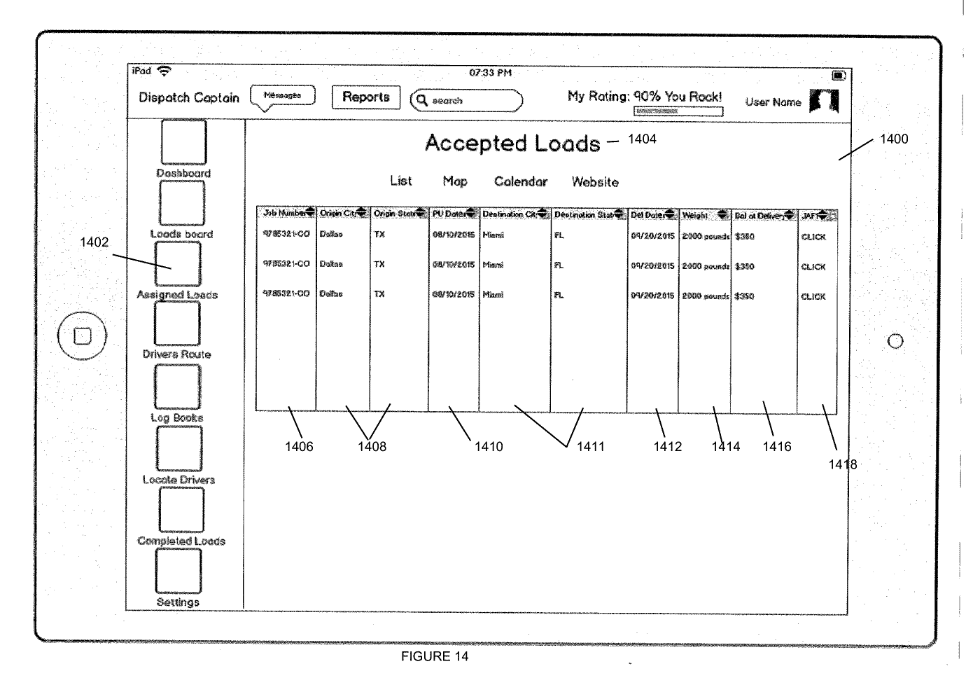

FIGS. 1-28 and descriptions of the FIGS. 1-28 together provide a list of functions and exemplary tablet application screens coinciding with several aspects of the disclosed invention. Whereas, the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated. Optionally, the information gathered by the disclosed invention may be stored on a cloud and other persons, such as a moving company employee, may be given access to the cloud. This may simplify the process and allow more data to be used without overloading various computer systems.

As such, those skilled in the art may appreciate that the conception, upon which this disclosure is based, may readily be utilized as a basis for designing other structures, methods and systems for carrying out the several purposes of the present invention. It is important, therefore, that the claims be regarded as including such equivalent constructions insofar as they do not depart from the spirit and scope of the present invention. A more complete understanding of the present invention, and the attendant advantages and features thereof, may be more readily understood by reference to the following detailed description when considered in conjunction with the accompanying drawings, wherein FIGS. 1-28, located after the step by step description, are representations of screens provided by a software application for use with a smart phone or tablet which guide an driver through the system and method.

By way of introduction only, the present embodiments provide methods and systems for dynamically managing transport of at least one item from a source location to a destination location, the method comprising: (1) ascertaining a mode of the administrator after authenticating an administrator; (2) performing a set of administrative functions if the administrator selected an administrative mode, wherein the set of administrative functions comprise: (a) previewing a set of loads board, a set of accepted loads, a set of loads situated in vicinity of a driver, a system alert, and a conversation; (b) assigning a load from the set of accepted loads to the driver and transmitting the assignment notification to drivers; (c) ascertaining a set of load attributes for loads requested from a set of external sources; (d) viewing a job acceptance form to ascertain a set of job attributes comprising: a job number, an origin location information, a destination location information, a packing instruction, a storage instruction, an inventory information, and a special handling instruction; (e) assigning at least one driver to a specific load after reviewing a set of accepted loads and loads assigned to each driver; (f) viewing the driver's log book for editing at least one of the driver's current log and the driver's past logs; (g) locating the driver and the driver's specific equipment on a map by selecting a location indicator on the map; (h) evaluating the driver's performance by viewing a set of assignments completed by the driver within a predefined time span; and (i) configuring a set of system parameters and generating reports reflecting system performance during a selected time span.

Further, the set of system parameters may comprise a number of licenses granted to the driver's employer company, a number of licenses granted to the driver, a set of company profile parameters for the company, and a set of equipment assigned to the driver. Furthermore, the corresponding set of load attributes comprise a load number, a source location city, a source location state, a source location zip, a destination city location, a destination state location, a destination location zip, a pick up date, a delivery date, a load weight measure, the distance measure between the source location and the destination location, and a load cash on delivery details.

The claimed method may further comprise the step of sorting the requested loads based on at least one of the set of load attributes. Additionally, the claimed method comprises the step of changing a load assignment from a first driver to a second driver. A log book of a selected driver during certain time span may be accessed to perform at least one of the following operations: editing the log book, using a past log book to show a historical trend for audit purposes, ascertaining the impact of a specific trip during a specific time span, and sending log book to a third party compliance observing entity. The claimed method further comprises the step of dynamically scheduling an additional load pickup for the selected driver, wherein the additional load is to be picked up at the location that is en route to the selected driver's previously scheduled assignment location. Likewise, the claimed method comprise the step of dynamically scheduling an additional load delivery for the selected driver, wherein the additional load is to be delivered at a location that is en route to the selected driver's previously scheduled assignment location. Additionally, the claimed method may comprise dynamically scheduling a partial load delivery for the selected driver, wherein the partial load is to be delivered at a location that is en route to the selected driver's previously scheduled assignment location. Furthermore, the claimed method may dynamically adding cargo from malfunctioning equipment located at a first location to the equipment of the selected driver, wherein the first location is en route to the selected driver's previously scheduled assignment location.

The method may further comprise the step of evaluating the performance of the selected driver by interpreting the statistical information associated with the selected driver, the statistical information comprising: a survey score and a claim percentage score of the selected driver. The method may comprise the step of evaluating the performance of a driver by viewing the details pertaining to a set of assignments completed by the driver within a predefined time span, wherein the predefined time span may be at least one of: 30 days, 60 days, and 90 days. Alternatively, the predefined time span may be the entire duration of the driver's service at a company. Furthermore, the method may comprise evaluating a company performance by viewing a set of assignments completed by the company within a predefined time span.

The method may perform a set of driver functions by a driver if the mode is a driver mode, wherein the set of driver functions may comprise: (1) viewing a dashboard displaying a list of loads assigned to the driver, a log book, weather information in the driver's location area, the driver's statistical information, and a set of useful links; (2) viewing a list of incomplete loads before selecting a job for viewing the load specific information; (3) acknowledging a new job assigned to the driver (4) accepting the job via a job acceptance form after ascertaining a set of job attributes; (5) getting directions to the selected job destination location and commencing paper work for the selected job; (6) revising the original cost estimation after reviewing at least one of: a move estimation as computed at time of booking, a furniture list, additional charges, additional services required during the pickup, additional services required during the delivery, and the packing instruction; (7) creating an inventory indicating a list of items to be moved from the source location to the destination location by taking a picture of the actual item and describing a condition of the item; (8) accepting a payment upon transmitting the inventory from the source location to the destination location; (9) creating an item damage claim if an item is damaged during the transportation; and (10) creating a missing item claim if the item is lost during the transportation.

The method may further comprise the step of the driver performing at least one post contract service at the time of delivery, wherein the post contract service was not accounted for at the pickup time, wherein the set of job attributes comprise a pickup address, a delivery address, a move initiating entity contact information, an estimated weight, a pickup date, a delivery date, the distance between the pickup location and delivery location.

A system for dynamically managing transport of at least one item from a source location to a destination location is disclosed, the system may be configured to (1) ascertain a mode of the administrator after authenticating an administrator; (2) perform a set of administrative functions if the administrator selected an administrative mode, wherein via the set of administrative functions the system is configured to: preview a set of loads board, a set of accepted loads, a set of loads situated in vicinity of a driver, a system alert, and a conversation; (2) assign a load from the set of accepted loads to the driver and transmit the assignment notification to drivers; (3) ascertain a set of load attributes for loads requested from a set of external sources; (4) view a job acceptance form to ascertain a set of job attributes comprising: a job number, an origin location information, a destination location information, a packing instruction, a storage instruction, an inventory information, and a special handling instruction; (5) assign at least one driver to a specific load after reviewing a set of accepted loads and loads assigned to each driver; (6) view the driver's log book for editing at least one of the driver's current log and the driver's past logs; (7) locate the driver and the driver's specific equipment on a map by selecting a location indicator on the map; (8) evaluate the driver's performance by viewing a set of assignments completed by the driver within a predefined time span; and (9) configure a set of system parameters and generating reports reflecting system performance during a selected time span.

Further, the set of system parameters may comprise a number of licenses granted to the driver's employer company, a number of licenses granted to the driver, a set of company profile parameters for the company, and a set of equipment assigned to the driver. The corresponding set of load attributes may comprise a load number, a source location city, a source location state, a source location zip, a destination city location, a destination state location, a destination location zip, a pick up date, a delivery date, a load weight measure, the distance measure between the source location and the destination location, and a load cash on delivery details. Additionally, the system may be configured to (1) view the set of load attributes after sorting the requested loads based on at least one of the set of load attributes. (2) change a load assignment from a first driver to a second driver. (3) access a log book of a selected driver during certain time span to perform at least one of: edit the log book, use a past log book to show a historical trend for audit purposes, ascertain the impact of a specific trip during a specific time span, and send log book to a third party compliance observing entity.

The system may further be configured to dynamically schedule an additional load pickup for the selected driver, wherein the additional load is to be picked up at the location that is en route to the selected driver's previously scheduled assignment location. Likewise, the system may be configured to dynamically schedule an additional load delivery for the selected driver, wherein the additional load is to be delivered at a location that is en route to the selected driver's previously scheduled assignment location. Additionally, the system may be configured to dynamically schedule a partial load delivery for the selected driver, wherein the partial load is to be delivered at a location that is en route to the selected driver's previously scheduled assignment location. Furthermore, the system may also be configured to dynamically add cargo from malfunctioning equipment located at a first location to the equipment of the selected driver, wherein the first location is en route to the selected driver's previously scheduled assignment location.

The system may evaluate the performance of the selected driver by interpreting the statistical information associated with the selected driver, wherein the statistical information comprise: a survey score and a claim percentage score of the selected driver. The system may also be configured to evaluate the performance of a driver by viewing the details pertaining to a set of assignments completed by the driver within a predefined time span, wherein the predefined time span may be at least one of: 30 days, 60 days, and 90 days. Additionally, and alternatively, the predefined time span may be the entire duration of the driver's service at a company. Similarly, the system may further be configured to evaluate a company performance by viewing a set of assignments completed by the company within a predefined time span.

FIG. 1 depicts login interface 100 according to one embodiment of the system of the disclosed invention. The interface 100 may be configured for administrators (Admin) and drivers to log into their respective accounts prior to accessing the system. FIGS. 1-28 illustrate various interfaces that may be displayed for admins or administrative accounts. Likewise the interface 100 may also be configured to create a new instance of administrator account for the first time administrators of the system. Note that the interfaces described in this application in FIGS. 1-28 are exemplary interfaces. As such, many other components may be added or taken out of the interfaces to accomplish the desired effect. Accordingly, any name other than the one displayed on the interface may be replaced for the names shown on the interfaces depicted in FIGS. 1-28. The interface 100 may be displayed on a computing device 101 which may be any Apple or Android device of an administrator upon the administrator launching a dispatch captain application, a logo 107 indicating name “Dispatch Captain” may be displayed on the interface 100. Several attributes associated with the computing device 101 such as time indicator 103, and battery indicator 105 may also be displayed on the interface 100.

Interface 100 may be displayed whereby administrators (Admin) and drivers can log into their respective accounts or the first time users may create their administrator or driver account. If user account is not set up, i.e. if the administrator is a first time user of the disclosed system, then the administrator may select create an account option 119. Alternatively, if user account is already set up, then the administrator may provide the user name and password before selecting the sign in option 117. Further, if administrator has forgotten the administrator's password then the administrator can select forgot password option 115 and the system may email the temporary password to the administrator.

If administrator using the computing device 101 is a registered user of the disclosed system, then the administrator may provide the administrator name in an input field 109, and password in an input field 111 prior to selecting a sign in option 117. If the administrator does not wish to have the computing device 101 save the administrator's user name and password information, the administrator may select a “forget me” option 113. Likewise, if the administrator is unable to recall the password then the administrator may select a forget password option 115, whereby the system may send a password reset link for the administrator at a predefined email address or provide password reset instructions via any other means of communication.

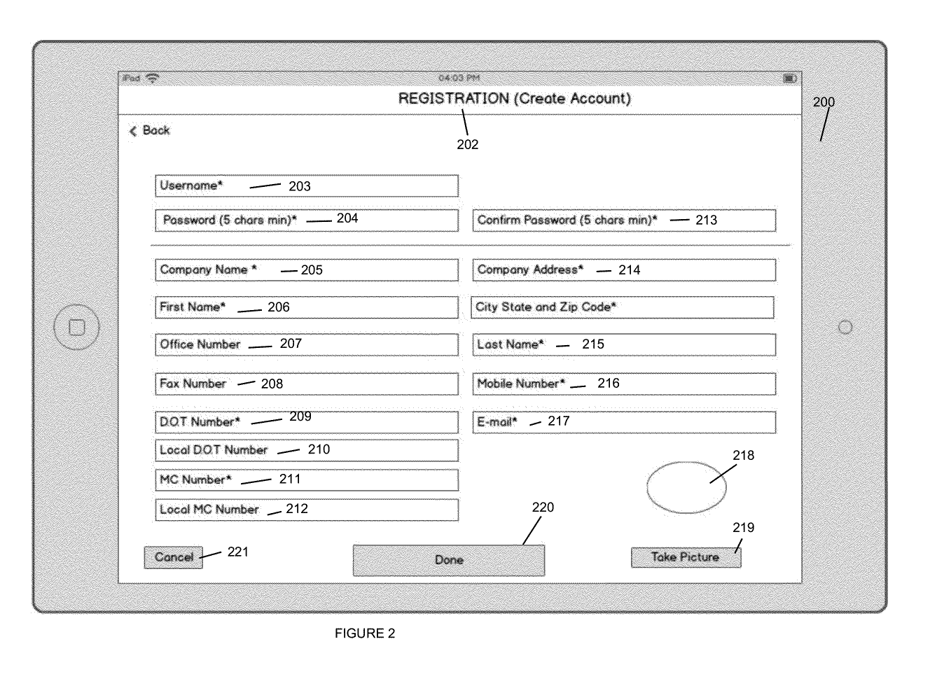

However, if the administrator is not a registered user of the disclosed system, the administrator may register with the disclosed system by selecting a create an account option 119. Upon selecting this option, the administrator may be presented an interface 200 illustrated in FIG. 2. The administrator may return to the main menu interface of the computing device 101 by selecting a return to main menu option 121 of the computing device 101.

Now referring to FIG. 2, showing a new administrator registration interface 200 according to one embodiment of the disclosed invention. In other words, a first time user may set up the administrator account by providing personal information to the disclosed system. The disclosed system may conduct a background check based on the information provided by the prospective user to authenticate the credentials provided by the prospective user. For example, the disclosed system may verify that the prospective user has active status to operate a vehicle using the department of transportation website.

To complete the registration process and for creating a personal registration record, the administrator may need to submit the administrator's user name in an input field 203, password in an input field 204 via registration interface 202 displayed on interface 200. The administrator may need to confirm password by re-entering the password in the input field 213. Further, the administrator may provide the administrator's company name and company address in the input fields 205 and 214 respectively. Similarly, the administrator's first name and last name may be specified in the input fields 206 and 215 respectively.

Likewise, administrator's office telephone number, cellular phone number (also known as mobile phone number), fax number, and email address may be indicated in input fields 207, 216, 208 and 217 respectively. Additionally, the administrator may specify the companies' department of transportation number [DOT], local department of transportation number, the motor carrier number [MC], and the local motor carrier number in the input fields 209, 210, 211, and 212 respectively. The administrator may optionally select a take picture option 219. In an event the administrator selects this option, the picture of the administrator taken via option 219 may be displayed in the display area 218. This registration information may be saved at a remote location over a network for subsequently validating the administrator's credentials upon the administrator selecting done option 220. Alternatively, the administrator may select cancel option 221 to discard the information previously submitted on the interface 200.

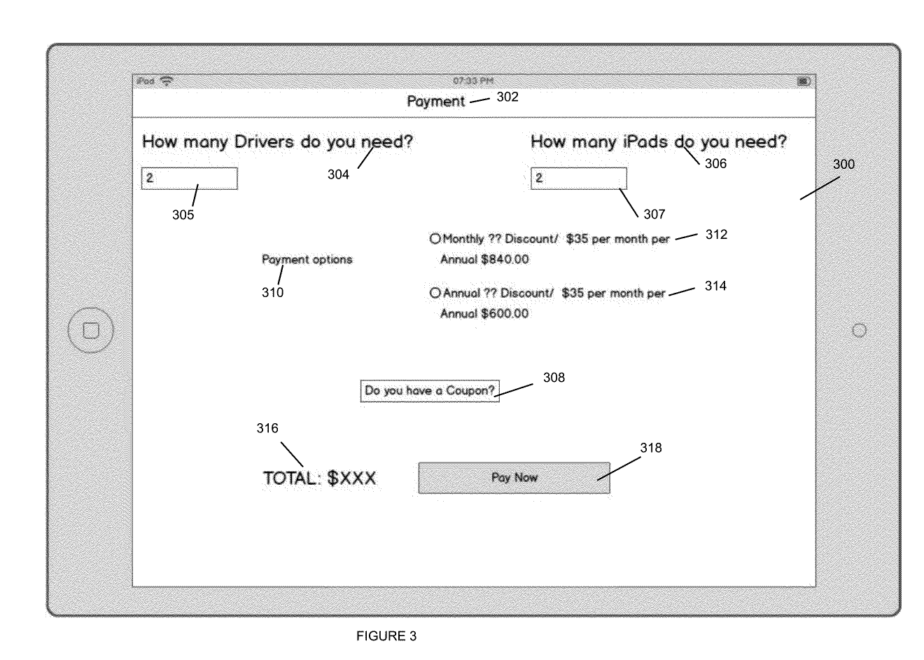

FIG. 3 depicts licensing options interface 300 according to one embodiment of the system of the disclosed invention. The interface 300 may be displayed on a computing device of an administrator. A logo 302 indicating caption “Payment” may be displayed at the top of the interface 300 upon the administrator signing in the system. After validating the credentials of the registered administrator of the disclosed system, the system may prompt the administrator to specify a number of drivers 304 and the number of tablet 306 required to execute a set of transportation assignments via interface 300. In the preferred embodiment of the disclosed invention, the disclosed system may require a company to pay per driver system usage charges. Thus, the disclosed system may cause a display of a query presenting two licensing options indicated by the reference numeral 310 to the administrator.

For example, the disclosed system may present a monthly discount offer to purchase two tablet and purchase two driver's licenses for $840 via option 312. Likewise, the disclosed system may present an annual discount offer to purchase two tablet and to purchase with two driver's licenses for $600 per year via option 314. If the company selects to use their own tablet, then prior to using the disclosed system, the company may be required to download an application executing the disclosed system on the company tablet. Notably, the company administrator may select to use the company tablet to use the disclosed system, or specify the number of tablet the company intends to purchase for using the disclosed system.

A desired driver's license count input area 305 may be displayed on the interface 300. In response to the query 304 asking the administrator how many driver's licenses does the company need, the administrator may provide the desired number of driver's licenses such as 3, 5, 10, 15, 20 and the like. Optionally, a driver's license cost indicator, not shown in FIG. 3, may be displayed adjacent to selection box option 305, which may indicate cost associated with the selected number of driver's licenses.

A desired tablet input area 307 may be displayed on the interface 300. In response to the query 306 asking the administrator how many tablets does the company need, the administrator may specify the desired number of tablet in the tablet input area 307. Optionally, a tablet cost indicator, not shown in FIG. 3, may be displayed adjacent to selection box option 307, which may indicate cost associated with the selected number of tablet.

The administrator may select a coupon option 308 in an event the administrator has a coupon the administrator intends to use. A coupon input interface, not shown in FIG. 3 may be displayed upon the administrator selecting the coupon option 308. In one embodiment of the disclosed system, the system may present an offer to the prospective companies such as “get 5% discount on total cost upon purchasing licenses for 25 drivers today”

A total cost of purchasing the licenses for the selected number of drivers may be shown at a total cost display area 316. Notably, if the coupon code entered by the administrator is accepted by the system, then resultantly, a new discounted price, after applying the coupon code may be reflected at the total cost display area 316. Optionally, an email containing the driver's licenses purchase and tablet purchase information such as number of licenses purchased, number of tablets purchased and the like may be sent to the administrator purchasing the licenses in conjunction with the administrator selecting the pay now option 318.

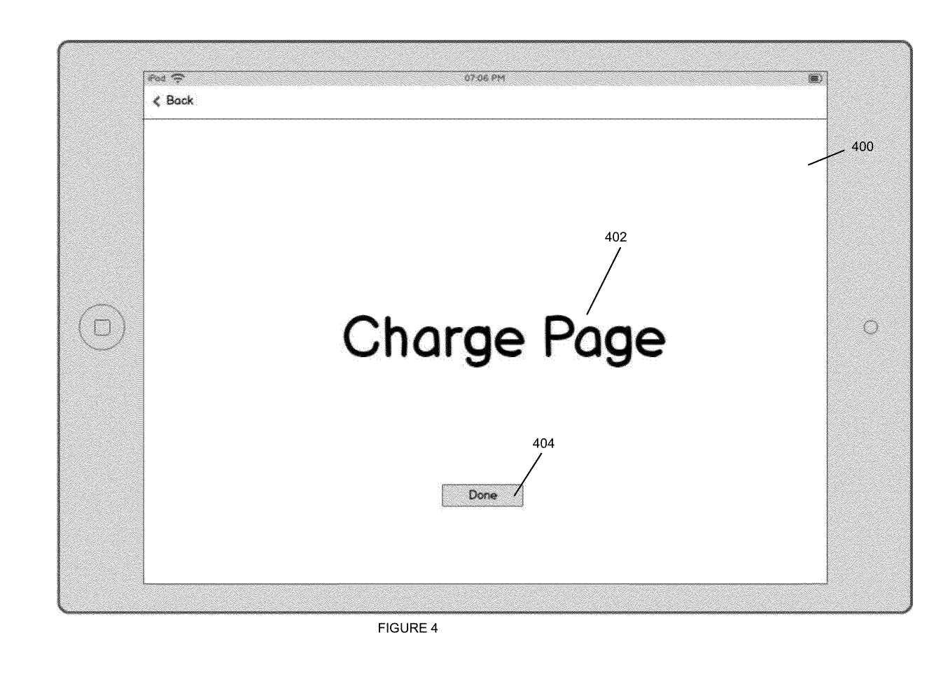

In other words, upon the administrator verifying the purchased driver's license number and purchased tablet number, optionally presenting the coupon code and after verifying the total cost display area 316, the administrator may proceed to conduct payment by selecting a pay now option 318 on the interface 300 as shown in FIG. 3. A payment interface 400, as shown in FIG. 4 may be displayed.

As seen in FIG. 4, via the payment/charge interface 400, the administrator may enter payment information such as credit card, bank account information, and the like. The administrator may select an option, not shown in FIG. 4, to agree to the terms and conditions, (also not shown in FIG. 4) that may be displayed on the interface 400 before selecting done option 404 to conclude the payment process for driver's license purchase and tablet purchase. Further, the administrator may optionally receive a payment confirmation email indicating the number of licenses purchased, and tablet purchased along with the total charge for purchasing the selected number of licenses and leasing the selected number of tablet.

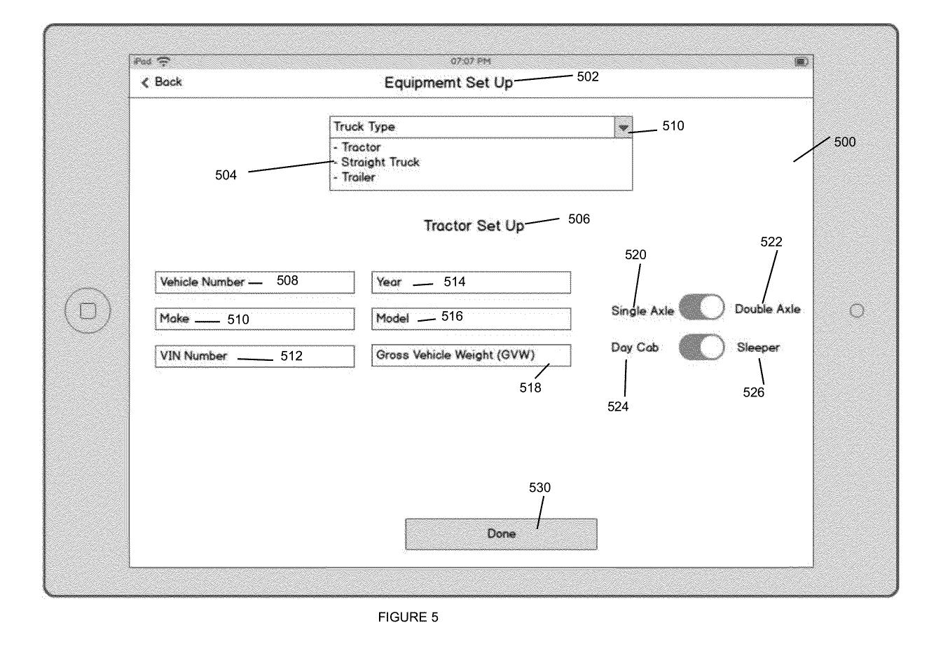

Turning to FIG. 5 now, showing an equipment configuration or set up interface 500 according to one embodiment of the system of the disclosed invention. The interface 500, may be displayed so the administrator may select equipment for completing a set of transportation assignments. For example, an equipment configuration set up indicator 502 may be displayed on the interface 500. A drop down list 510 may be displayed on the interface 500 presenting equipment options for the administrator.

As seen in FIG. 5, interface 500 shows three equipment options that are presented to the administrator. Among the three equipment options presented on the interface 500, the option tractor indicated by the reference numeral 504 is selected by the administrator. In response, the tractor set up configuration 506 may be displayed on the interface 500. As shown in FIG. 5, the details pertaining to the selected equipment i.e. tractor 504 such as a vehicle number 508, which may identify a vehicle, for example, truck 1, truck 2 etc., a vehicle make 510, a vehicle identification number 512, a vehicle manufacturing year 514, a vehicle model number 516, and a gross vehicle weight 518 may be displayed on the interface 500.

Furthermore, via interface 500, the administrator may be asked to specify the desired vehicle attributes by selecting one or more equipment attribute options from a set of vehicle attribute options such as single axle option 520, a double axle option 522, a day cab option 524, a sleeper option 526, and the like. The disclosed system may take into consideration these vehicle attributes, while conducting the job assignments. For example, while assigning a vehicle for a long distance transport, the system may prefer a vehicle with a sleeper option to vehicle with just a day cab. This equipment set up information may be saved for subsequent usage upon the administrator selecting done option 530.

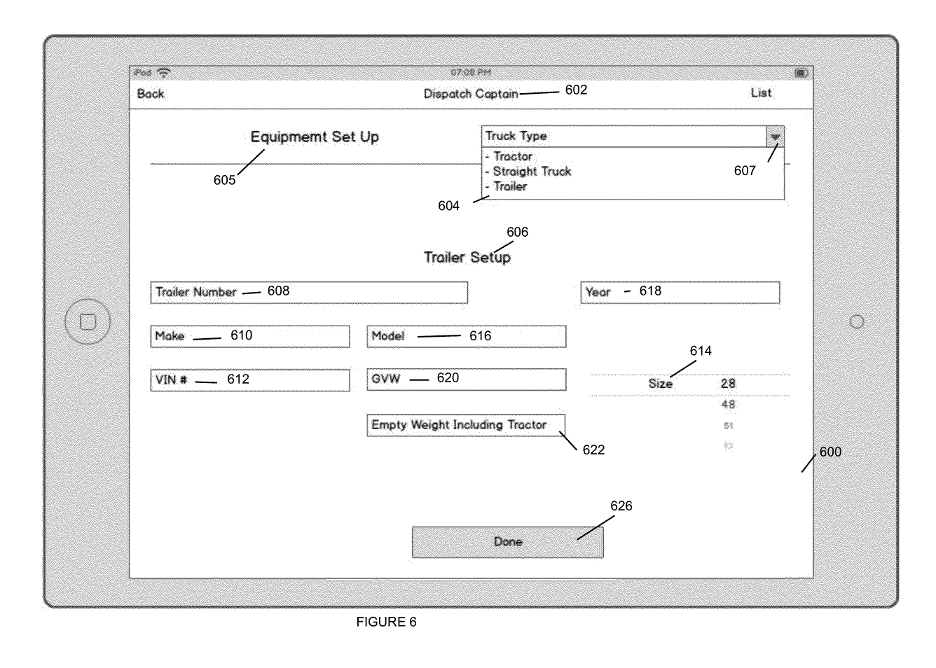

Turning now to FIG. 6, showing dispatch captain caption 602 on the interface 600 according to one embodiment of the system of the disclosed invention. For example, an equipment configuration set up indicator 605 may be displayed on the interface 600. A drop down list 607 may be displayed on the interface 600 presenting several equipment options for the administrator. Among the three equipment options presented on the interface 600, the option trailer indicated by the reference numeral 604 is selected. In response to this selection, the trailer set up configuration 606 is displayed on the interface 600.

As shown in FIG. 6, the trailer set up configuration 606 may indicate the details pertaining to the selected equipment i.e. trailer 604 may be displayed such as trailer number 608, trailer make 610, trailer identification number 612, trailer size 614, trailer model 616, trailer manufacturing year 618, gross vehicle weight 620, and empty weight including tractor 622. This equipment set up information may be saved for subsequent usage upon the administrator selecting done option 626. In one embodiment of the disclosed invention the size of the trailer may be 28, 48, 51 or 53 feet.

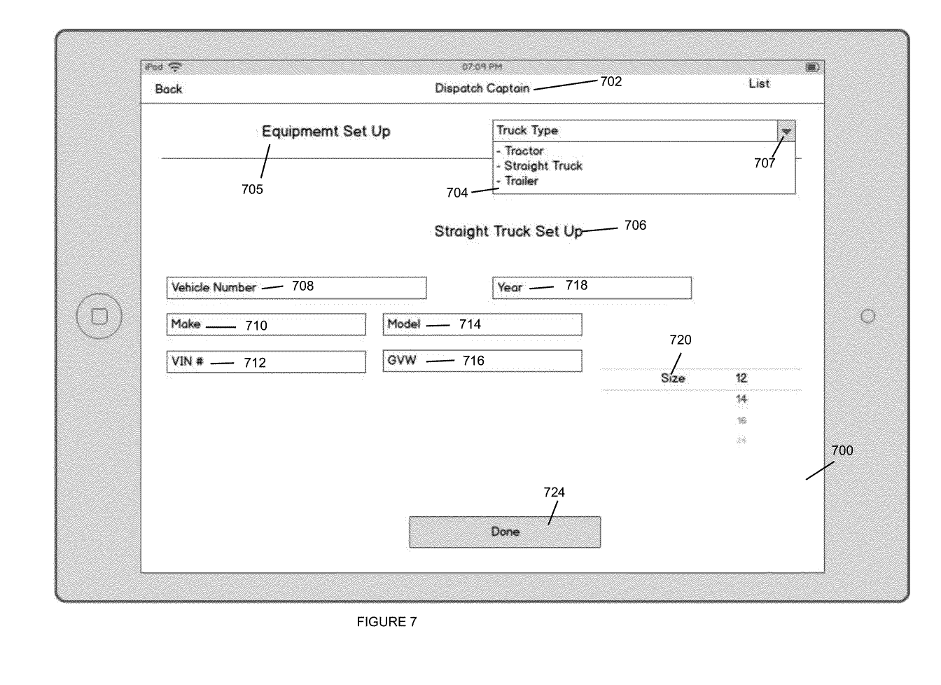

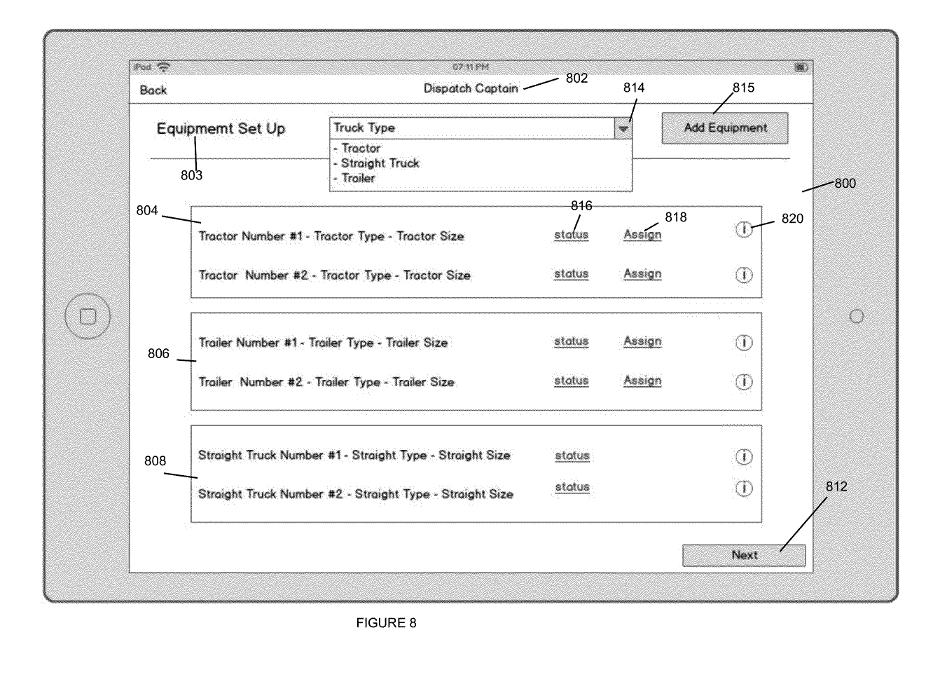

Alternatively, if the administrator had selected the equipment option type straight truck from the drop down list 607 in FIG. 6, an interface 700 shown in FIG. 7 may be displayed. FIG. 7 shows dispatch captain caption 702 on the interface 700 according to one embodiment of the system of the disclosed invention. For example, an equipment configuration set up indicator 705 may be displayed on the interface 700. A drop down list 707 may be displayed on the interface 700 presenting several equipment options for the administrator. As seen in FIG. 7, among the three equipment options presented on the interface 700, the option straight truck indicated by the reference numeral 704 is selected by the administrator. In response to this selection, the straight truck set up configuration 706 is displayed on the interface 700.

As shown in FIG. 7, the details pertaining to the selected equipment i.e. straight truck 704 may be displayed such as vehicle number 708, vehicle make 710, vehicle identification number 712, vehicle size 720, vehicle model 714, vehicle manufacturing year 718, and gross vehicle weight 716. In one embodiment of the disclosed invention the size of the straight truck may be 12, 14, 16, 24, 28, or 30 feet. This equipment set up information may be saved for subsequent usage upon the administrator selecting done option 724.

The summary of the equipment set up configuration as shown and described in conjunction with FIGS. 5, 6, and 7 is illustrated in FIG. 8. A dispatch captain caption 802 may be displayed on the interface 800 according to one embodiment of the system of the disclosed invention. For example, an equipment configuration set up indicator 803 may be displayed on the interface 800. A drop down list 814 may be displayed on the interface 800 presenting several equipment options for the administrator. Among the three equipment options presented on the interface 800, the administrator may select an option from the drop down list 814. Additionally, the administrator may select add equipment option 815 to add yet another equipment to the existing equipment configuration as displayed on the interface 800.

The tractor set up information 804, the trailer set up information 806, and the straight truck set up information 808 may be displayed on the interface 800. Additionally, the administrator may have an ability to view status of equipment by selecting a status hyperlink 816 on the interface 800 to determine whether tractor number #1 and tractor number #2 are in active state or inactive state. Furthermore, the administrator may by selecting option 820 edit configuration information of an equipment, by selecting an edit hyperlink 818 on the interface 800 to change assignment of the tractor number #1 or tractor number #2.

Accordingly, if the administrator selects the status hyperlink 816 displayed adjacent to tractor number #1 in the tractor set up information display area 804, the administrator may discover that tractor number #1 is in active state and tractor number #2 is in inactive state. Administrator may change the status of the tractor number #1 to inactive state and status of tractor #2 to active state. Accordingly, administrator may via status hyperlink 816 shown on interface 800, change status of equipment.

In other words, administrator may view a list of equipment that has been previously added and if needed may also have the ability to add new equipment. Administrator via interface 800 may place the equipment in an active state or an inactive state by selecting status hyperlink 816. Likewise, administrator may also assign tractors to a trailer by selecting assign hyperlink 818. Additionally, administrator may edit equipment information by selecting the i hyperlink indicated by the reference numeral 820.

Notably, unlike the tractor information display area 804, and the trailer information display area 806, the straight truck information display area 808 may not have an assign option 818.

The tractor set up information 804 may include tractor identification number, tractor type, tractor size information, tractor status information, tractor assignment link and the like. Likewise, the trailer set up information 806 may include trailer identification number, trailer type, trailer size information, trailer status information, trailer assignment link and the like. Similarly, the straight truck set up information 808 may include straight truck identification number, straight truck type, straight truck size information, straight truck status information and the like. This equipment set up information may be saved for subsequent usage upon the administrator selecting next option 812.

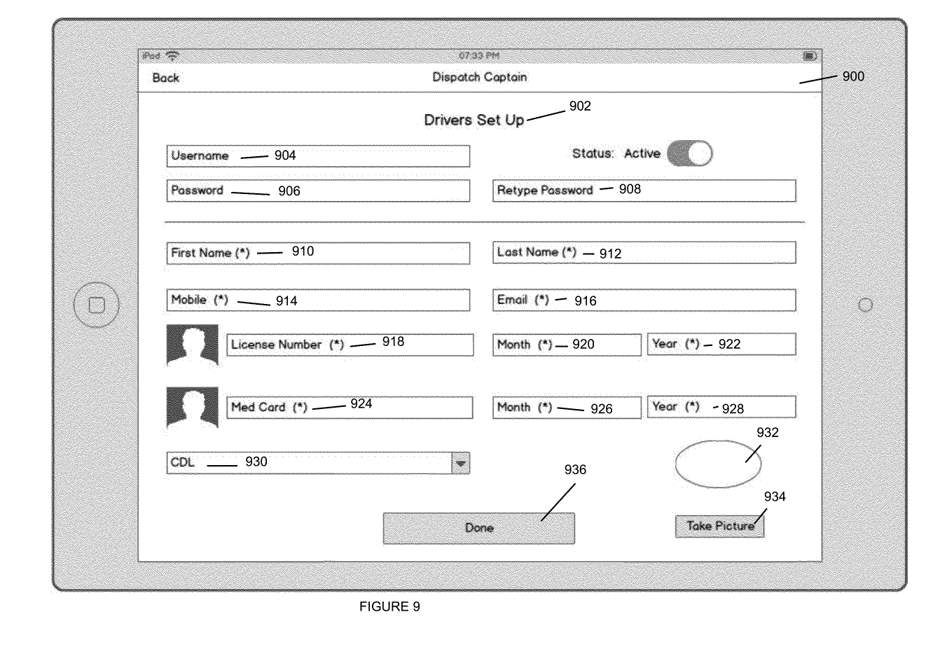

After performing the equipment configuration and selecting next option 812, the administrator may proceed to perform driver set up configuration, as shown in FIG. 9. An interface 900 may display the driver set up information 902 showing the driver's profile information such as driver's user name 904, and password 906. The system may, for validation purposes require the admin to retype the password in the input area 908. Further, interface 900 may display input areas 910 and 912 respectively configured to accept the driver's first name and last name. Furthermore, the system may display input areas 914, 916, 918, 920 and 922 which may be respectively configured to accept the driver's cellular phone number, email address, driver's driving license number, and the month and year when the driver's license will expire. An alert may be sent to the admin in an event if the driver's license is already expired.

Likewise, the system may display input areas 924, 926, 928 and 930 which may respectively be configured to accept the driver's medical card number, the month and year when the driver's medical card expires, and commercial driver's license [CDL] information respectively. In the preferred embodiment of the disclosed invention, the system may periodically ascertain that both the driver's driving license and medical cards are valid. In an event either of the two cards becomes invalid then an alert notification may be sent to the administrator.

In one embodiment of the disclosed invention, the system may determine the validity of the various driver's driving licenses by periodically establishing a communication link with the department of motor vehicles. In this embodiment of the disclosed invention, the system may determine the validity of the various drivers' medical cards by periodically establishing a communication link with the driver's insurance carrier.

Optionally, the disclosed system may maintain safety records and medical records of various drivers based on the information gathered via the aforementioned communication links. The safety records and the medical records may play a role in allocating various transportation assignments. The admin may optionally select a take picture option 934. In an event the admin selects this option, the driver's profile picture taken via option 934 may be displayed in the display area 932. Optionally, the take picture option 934 may also be employed to take pictures of the driver's medical card, the driver's driving license, and the like. This driver set up information may be saved for the subsequent usage upon the administrator selecting done option 936.

Administrators may have the ability to select a desired number of drivers licenses. In this context, license may indicate permission for using the disclosed system for a predefined fee. Once the number of licenses is selected, administrator may select the pay now option and proceed to identify the form of payment and other billing information. The administrator may be required to pay onetime set up fee, along with a monthly recurring fee that may be charged per license.

The driver may need to have a license to use the disclosed system, this license is different from driver's state issued driving license. In one embodiment of the disclosed invention, each corporation intending to use the disclosed system may be required to purchase one license per driver prior to using the disclosed system. In this embodiment, the system may mandate a valid license. Accordingly, the disclosed system may verify that each driver has a valid DOT license and a valid MC license. An alert may be generated in an event either one or both of the aforementioned licenses are invalid.

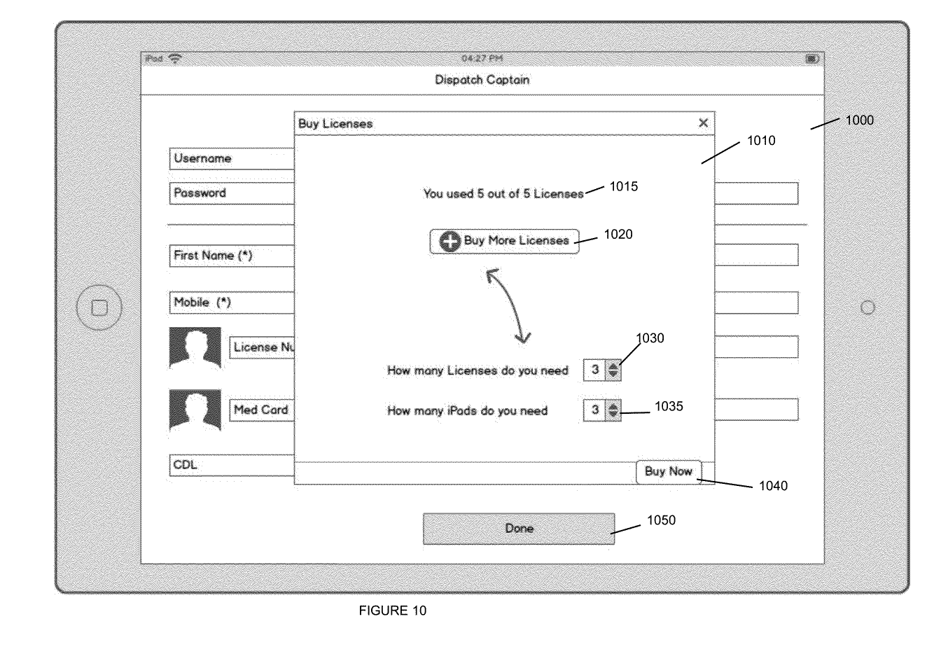

While the disclosed system may not restrict a driver from using the system due to expired or revoked driver's license, the disclosed system may optionally notify the administrator of company of the infractions. Each company may handle the infractions as per the company guidelines. As illustrated in FIG. 3, an administrator may purchase a certain number of licenses via interface 300. Subsequently, upon receiving the payment for the certain number of licenses, the licenses may be issued to the administrator's company. Many factors may be considered while the company allocates the system licenses to the company drivers such as driver's record of years of driving, law violation, customer service feedback, known behavioral tendencies, monthly assignment schedule and the like. FIG. 10 illustrates a license purchase interface 1010 shown on an interface 1000 according to a preferred embodiment of the disclosed invention.

The license purchase interface 1010 may present a license usage indicator 1015 to indicate the number of purchased licenses and the number of licenses that have been used up. If administrator attempts to add more drivers than licenses purchased, a pop up interface may appear advising the administrator that more licenses need to be purchased before adding a new driver. Upon the administrator selecting the number of licenses to be purchased 1030, and selecting buy now option 1040, the administrator may be directed back to payment screen to enter form of payment.

For example, in FIG. 10, the company appears to have used all 5 out of 5 licenses that have been purchased by the company. In this case, the administrator may be prompted to purchase more licenses by selecting the buy more licenses option 1020. After selecting this option, the administrator may specify the number of licenses the administrator desires to purchase by selecting a number of desired licenses at input area 1030. Similarly, the administrator may specify the number of tablet the administrator desires to purchase by selecting a number of tablet at input area 1035. Then the administrator may purchase the selected number of licenses and purchase the selected tablet by selecting buy now option 1040. The administrator may conclude license purchase activity by selecting done option 1050.

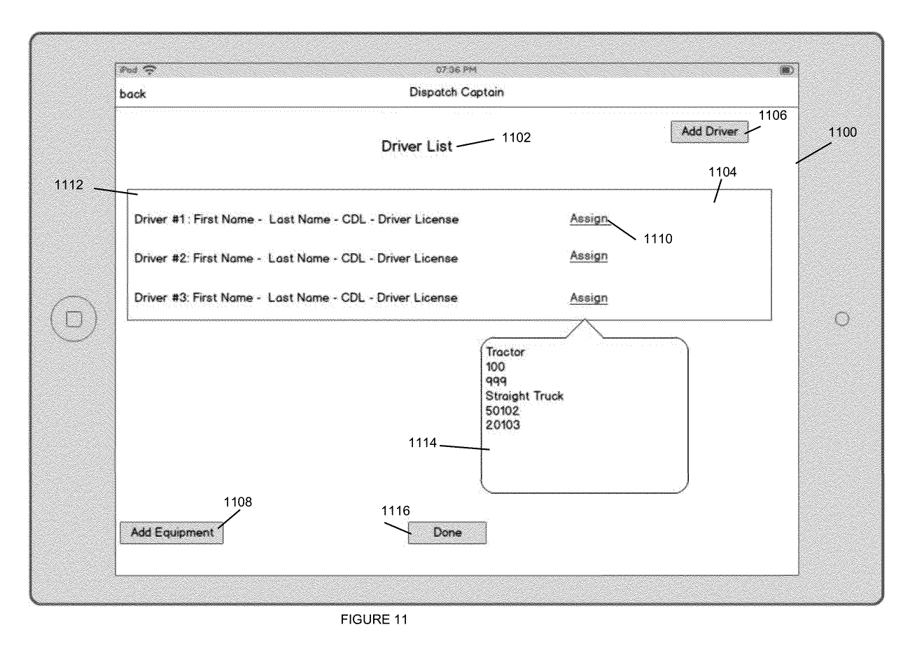

After configuring various equipment and drivers, the administrator may proceed to assigning a specific driver to specific equipment via interface 1100 shown in FIG. 11. For example, driver list 1102 may be displayed on the interface 1100. The display area 1104 may indicate driver information 1112 such as driver's first and last name, license number, CDL, and the like. By selecting an assign option 1110 for a driver, the driver may be assigned to specific equipment which has not yet been assigned to a driver. A list of active and inactive drivers may be displayed on the interface 1100. Additional driver may be added to the display area 1104 by selecting add driver option 1106. Administrator may be able to add drivers, update driver status, edit driver information and assign equipment to active drivers via interface 1100.

Furthermore, additional equipment may be added to the display area 1104 by selecting add equipment option 1108. Administrator may have the ability to select an equipment i.e. tractor, trailer or straight truck and add the selected equipment to their list of available equipment via add equipment option 1108. In the preferred embodiment of the disclosed invention, if a given equipment cannot be used the status of the equipment may be set to inactive. The administrator selecting the assign option 1110 may cause display of vehicle information area 1114 showing a list of available equipment. This driver and equipment assignment information may be saved for subsequent usage upon the administrator selecting done option 1116.

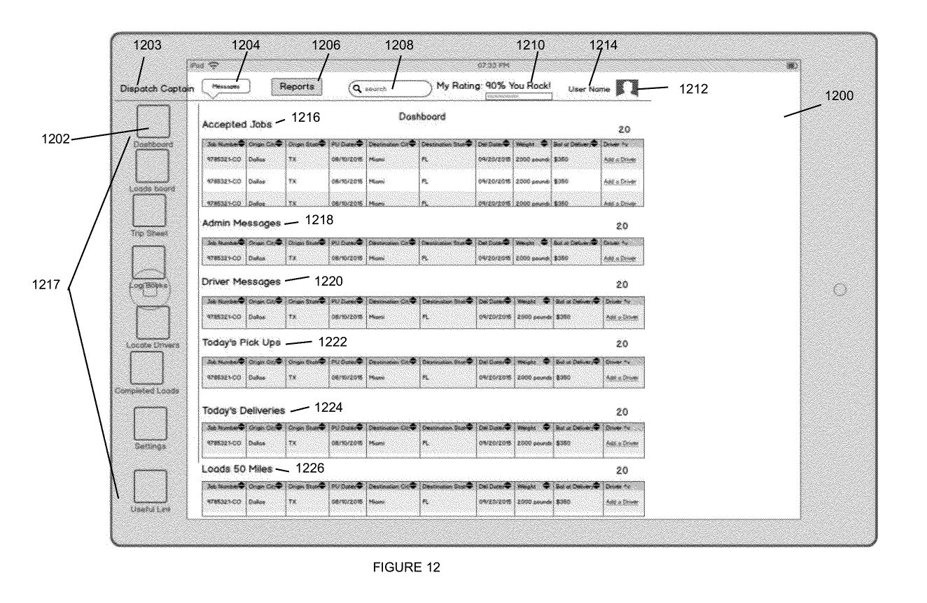

Now turning to FIG. 12, showing a dashboard interface 1200 displayed upon the administrator selecting a dashboard option 1202. Admins may be able to view information regarding loads that have been accepted 1216, messages sent to administrator 1218, messages sent to driver 1220, today's scheduled pickup jobs 1222, today's scheduled delivery jobs 1224, notification from booking companies, loads located within 50 miles of a driver location 1226. In other words, interface 1200 may show alerts, jobs that are being picked up or delivered today, conversations between drivers and administrators, and the like. Via interface 1200, admins can assign accepted loads to a driver and send messages to drivers. Several options 1217 may be displayed on the side bar, using the options 1217, administrator may toggle between the following interfaces: loads board interface, trip sheets interface, log book interface, driver location interface, completed loads interface, settings interface, reports interface, useful links interface, and the like.

Assignment information pertaining to all the jobs that have been accepted by a company may be displayed at the accepted jobs area 1216. In other words, a company may accept certain jobs from a job board which may be a central repository holding a set of unfinished transportation jobs. After accepting the job, the company may assign a driver. Typically the driver may be associated with specific equipment. An exemplary dashboard interface 1200 is shown in FIG. 12 may display a header portion indicating information such as caption dispatch captain 1203, messages 1204 sent to the admin, reports 1206 generated for the driver, search area 1208 for searching specific information displayed on the interface 1200, company rating information 1210, the consumer picture 1212 and the admin name 1214 and the like.

Further, the companies accepted jobs 1216 indicating job number, source location city and state, destination location city and state, date of delivery, weight of the cargo, and the like may be displayed on the interface 1200. An administrator may send a message to a first driver via the disclosed system. Notably, a message read indicator, not shown in FIG. 12 may enable the administrator to determine whether or not the first driver has read the message. For example, when the administrator sends a message to the first driver such as new job needs to be picked up en route to the previously scheduled delivery, then the message read indicator displayed to the administrator may allow the administrator to precisely know if the driver has read the message. The administrator may then select to send the same message to another driver if the administrator fails to receive a read message acknowledgement form the first driver. This feature may especially be helpful in communicating time sensitive messages.

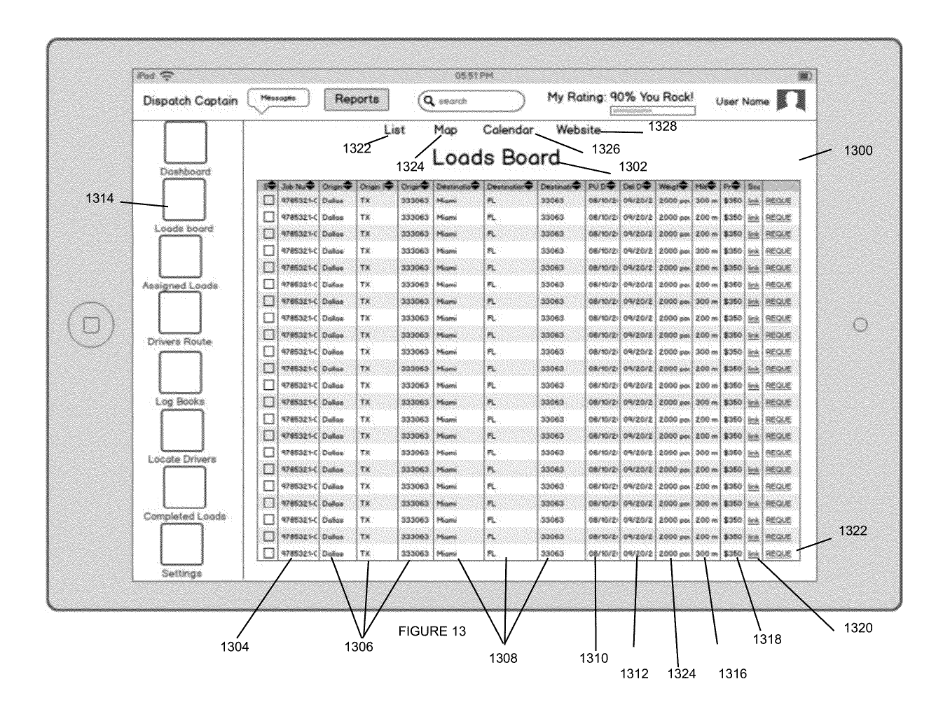

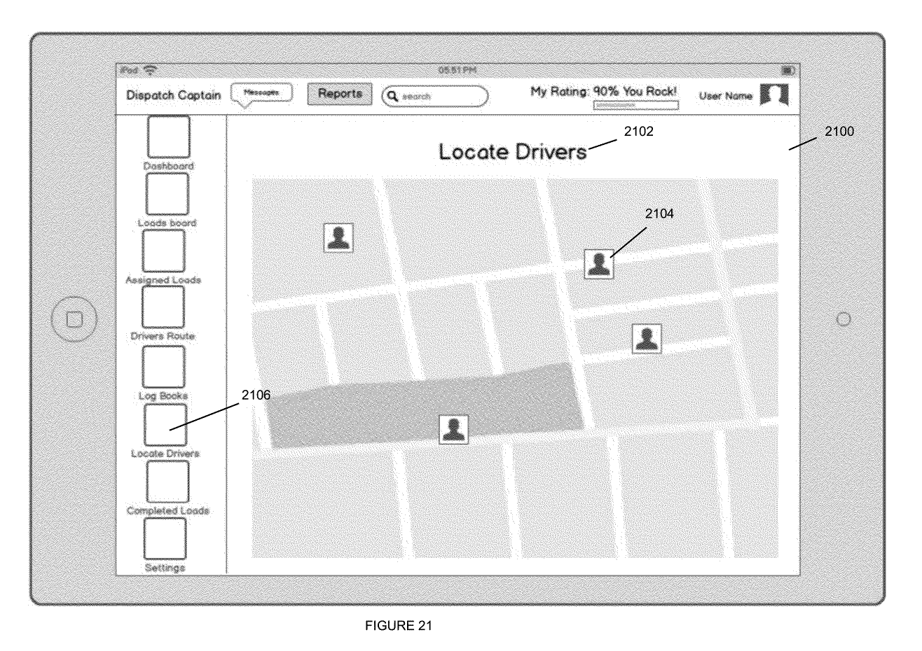

At any given time, many loads of many drivers, using several equipment may be managed by the administrator. Thus the administrator may need to view and request loads from numerous boards. This function may be performed by selecting a loads board option 1314 on an interface 1300 shown in FIG. 13. As seen on loads board interface 1300, four different options can be displayed to the administrator. A list option 1322 is displayed in FIG. 13, a map option 1324 is displayed in FIG. 21. Map view may show driver locations and also jobs that can be picked up using color codes. Further, a calendar option 1326 may display details pertaining to all the accepted jobs that are to be performed on a specific day or date.

Likewise, a website option 1328 may contain useful links such as location of the nearby fuel station, hotels, weight station, packing material retailer location and the like. The administrator may be able to view information on the loads board 1302 such as load number 1304, origin city, state and zip 1306, destination city, state and zip 1308, pick up dates 1310, delivery dates 1312, weight of load 1314, distance from origin to destination 1316, COD 1318, and the like via the interface 1300. Additionally, by selecting the option reque 1322 for any job listed on the interface 1300 the administrator may notify the booking company of the administrator's company's interest in accepting a specific job. By selecting the link option 1320, the administrator can locate the nearest weight station.

Using interface 1400, administrator may view a set of accepted loads and a set of loads assigned to each driver. Administrator can also view all jobs that are assigned to all drivers along with the details pertaining to a specific job. The loads board may display jobs that are available for moving companies to request. Accepted loads are loads that were requested by the admin, and in response, assigned by the booking company to the admin's company. The admin may need to click the JAF link and accept job. The administrator may view information pertaining to accepted loads 1404 such as load number 1406, origin city and state 1408, destination city and state 1411, pick up dates 1410, delivery dates 1412, weight of load 1414, COD 1416, Job acceptance form (JAF) 1418 and the like, via the interface 1400.

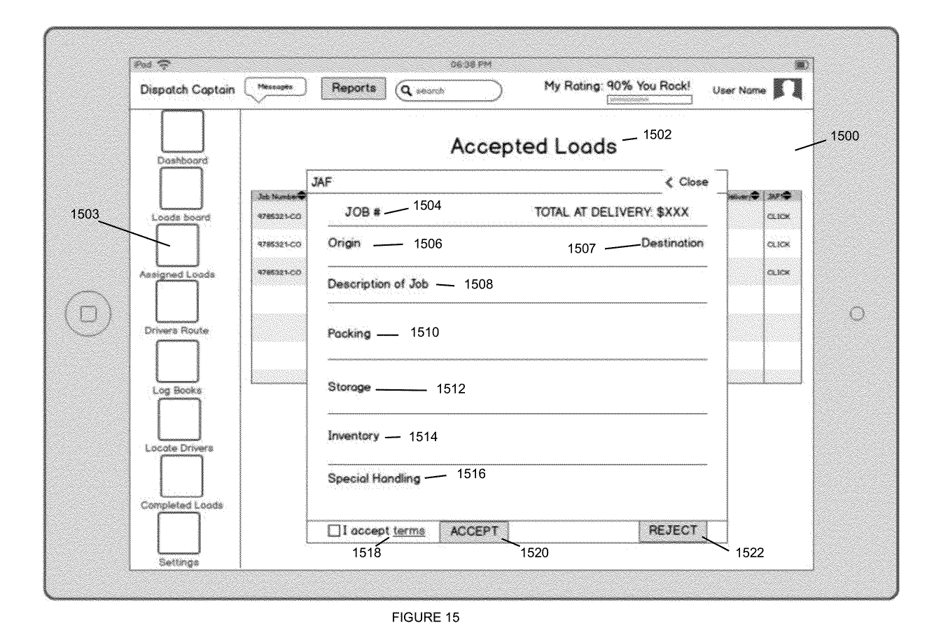

Additionally, by selecting the option JAF 1418 for any job listed on the interface 1400 the administrator may be able to view an interface 1500 displayed in the FIG. 15. In other words, a booking company may broadcast jobs, the administrator may accept or reject the job that the booking company assigned to them via JAF. Then the job may get assigned to the driver and the accepted job may become unavailable in the system.

Now turning to FIG. 15, showing job acceptance form interface 1500 displaying details of accepted loads 1502. In particular, the interface 1500 may enumerate information pertaining to accepted loads. Interface 1500 may display accepted loads information such as a job number 1504, origin location information 1506 such as origin location city, state and zip, destination location information 1507 such as destination location city, state and zip, description of job 1508, packing information 1510, storage information 1512, inventory information 1514, special handling information 1516, option to accept terms 1518, option 1520 to accept load information displayed on the interface 1500 and option 1522 to decline load information displayed on the interface 1500.

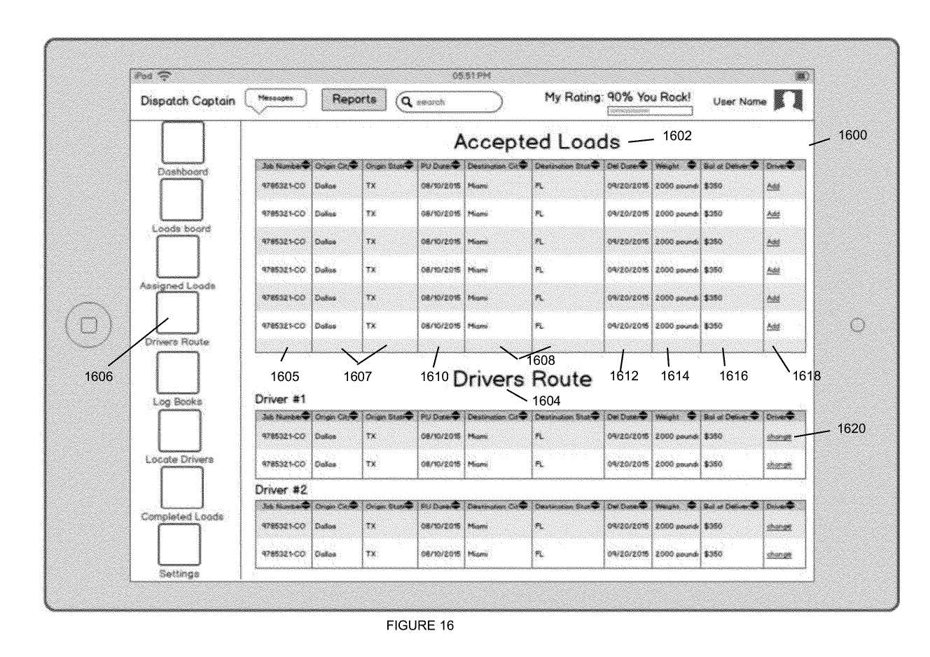

Alternatively, the administrator may view the details pertaining to various accepted loads and several routes scheduled for various drivers at a glance. This function can be accomplished via an interface 1600 shown in FIG. 16, specifically by selecting a driver's route option 1606 on the interface 1600. On the interface 1600 shown in FIG. 16 the administrator may view the accepted loads and loads assigned to each driver. Advantageously, the administrator may assign drivers to loads and also change the previously defined driver-load assignments.

In other words, the administrator may view, under the category of accepted loads 1602, information regarding the accepted loads such as load number 1605, origin city and state 1607, destination city and state 1608, pick up dates 1610, delivery dates 1612, weight of load 1614, COD 1616, add driver option 1618 and the like, via the interface 1600. Additionally, by selecting the add driver option 1618 for any accepted load/job listed in the table of accepted loads 1602, the administrator may be able to add a driver to the selected load.

In a similar manner, the administrator may view various drivers routes 1604 on the interface 1600. Information regarding configured route scheduled for each accepted load may be displayed in the driver's route display area 1604. This information may be identical to the information shown in the accepted loads table 1602, except for a functionality whereby by selecting an change option indicated by the reference numeral 1620 in the drivers route display area 1604 for a specific job, the administrator may change the route defined from the source location to the destination location to complete the selected job.

According to one embodiment of the disclosed invention, not shown in FIG. 16, the source state is a selectable link and upon selecting the selectable source city in the driver route table 1604 for a specific job, the administrator may view several possible routes from the selected source city to the identified destination city. In this embodiment, the administrator may have an option of selecting shortest path between the source city and the destination city.

Alternatively, the administrator may have an option of identifying an economic path between the source city and the destination city, for example, path that is not a shortest path, but one that can combine two separate moves which happen to be in vicinity of one another. Advantageously, in this embodiment of the disclosed invention, the administrator may have the ability to configure filters for selecting a path for transporting the goods from the source location to the destination location.

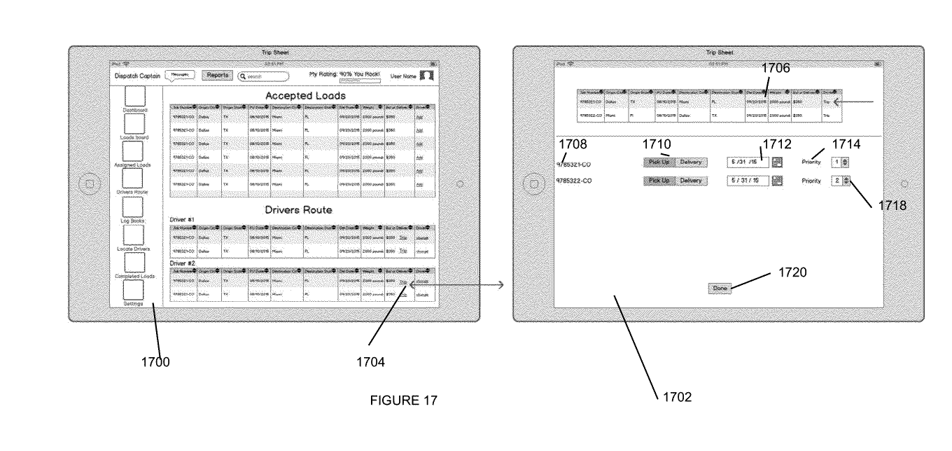

Turning now to FIG. 17 showing job driver's job priority configuration interface according to one embodiment of the disclosed invention. The administrator may view a list of current jobs for each driver via an interface 1700 shown in FIG. 17. Administrator may be able to set a specific pickup and or delivery date for an upcoming move. This is accomplished by the administrator selecting trip option 1704 on the interface 1700, which may cause the display of the interface 1702 also shown in FIG. 17. The administrator may select a job that is assigned to a driver by selecting trip option 1704.

Then the details pertaining to the selected job may be displayed on the interface 1702, such as job identification number 1708, nature of job (pickup/delivery) 1710, scheduled job pickup/delivery date 1712, job priority 1714 and the like. The administrator may change the scheduled job pickup/delivery date 1712 by selecting a new date via calendar 1716. Similarly, the scheduled job priority 1714 may be changed by selecting a priority via priority adjustor 1718. Once changes are configured by the administrator, the changes may be saved by selecting done option 1720. Resultantly, the system may notify the changes to the driver may be so he/she is aware when the move is to be completed. In an event, if multiple moves are scheduled for a single day, the administrator may set an order of priority in which the moves are expected to be completed.

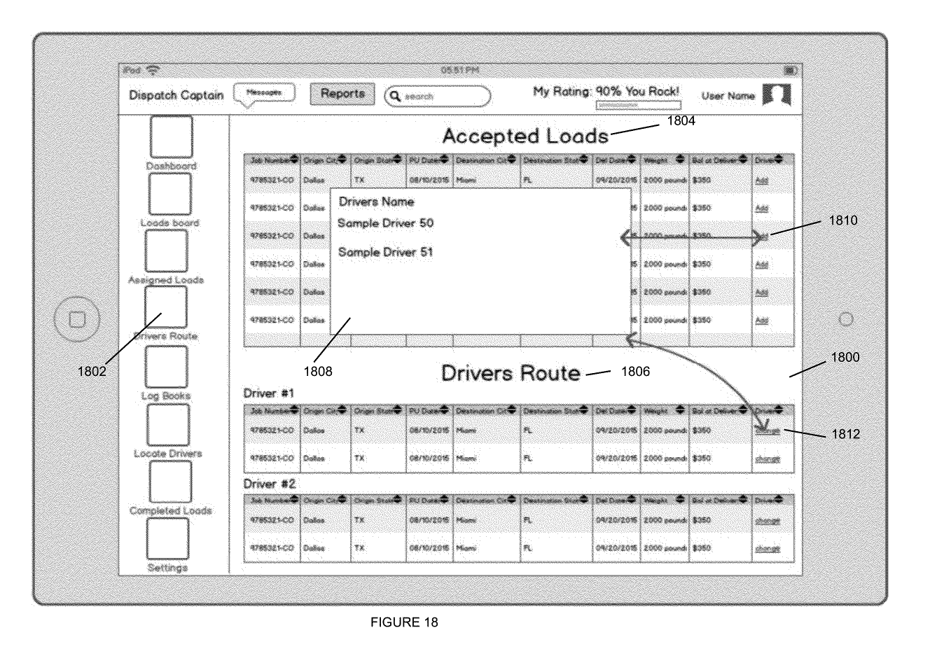

Load assignment modification interface 1800 according to one embodiment of the disclosed invention is shown in FIG. 18. Administrators may assign drivers to loads and change previously assigned loads via interface 1800 which is displayed upon administrator selecting driver's route option 1802. Both the accepted loads display area 1804 and the driver's route display area 1806 have been described in conjunction with FIG. 16. The administrator may, by selecting the hyperlink add indicated by the reference numeral 1810, assign a driver to a load.

Likewise, by selecting the hyperlink change indicated by the reference numeral 1812, the administrator may change the previously configured driver assignment and assign a new driver to the given load. In other words, additional drivers may be added via add hyperlink 1810, and assigned driver may be replaced via change hyperlink 1812. Notably, the administrator selecting either the add hyperlink 1810 or change hyperlink 1812 may cause the display of interface 1808, which may contain a list of all active drivers to select from. For each driver in the list of the active drivers, interface 1800 may display driver information such as driver name, driver identification number and the like.

Further, administrator may also edit logs that have not been signed and closed. Each edit by the administrator may also display a history for audit purposes. Pre and post trip logs may also be viewed by the administrator. Advantageously, administrator may also send log books to third party compliance companies for processing.

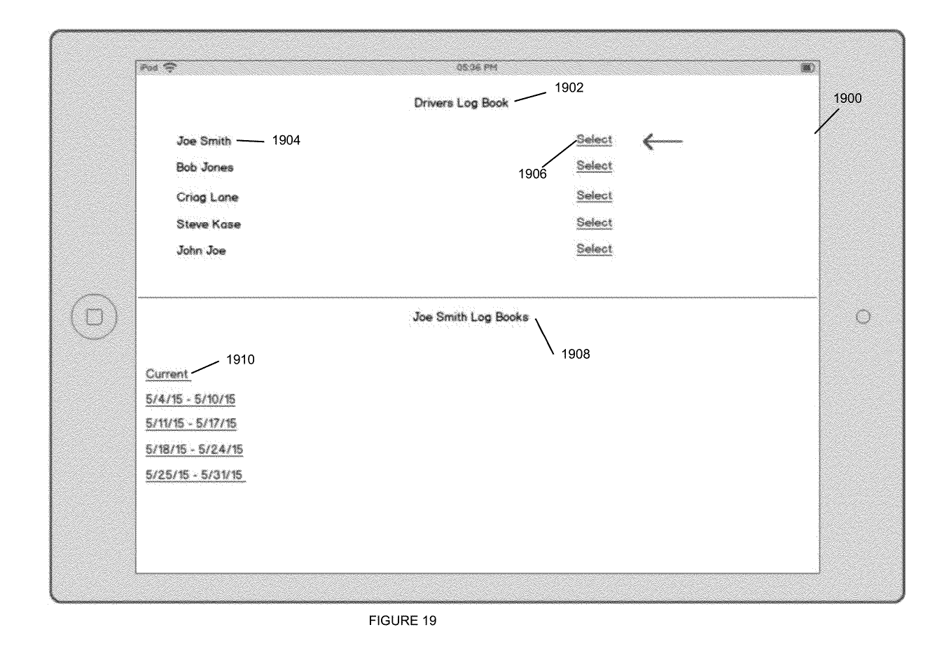

An example of driver log book 1902 is shown on driver log book search interface 1900 in FIG. 19. The administrator may designate a name of a driver 1904 and select option 1906 to cause information display 1908 of the selected driver. In FIG. 19, for example the administrator has selected a driver named “Joe Smith” and the information display 1908 may present different timelines 1910 such as current, 5/4/15/-5/10/15, 5/11/15/-5/17/15, 5/18/15/-5/24/15, and 5/25/15/-5/31/15. The administrator may select any time span to view Joe Smith's log book in that time span.

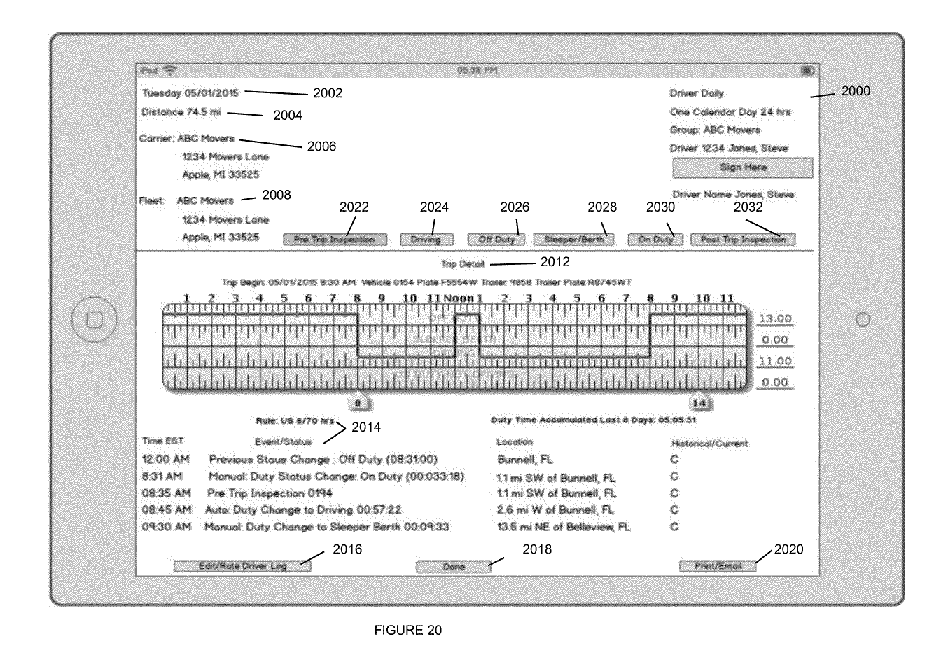

An example of such log book is shown in FIG. 20, wherein, interface 2000 may show information regarding the displayed log such as driver's name 2010, date 2002, distance 2004, carrier name and address 2006, fleet name and address 2008. In an event a driver is using the disclosed system for the first time, then the driver may need to manually enter the miles on the odometer, but subsequently, the disclosed system may get the miles driven via the global position system in communication with the driver's communication device such as a tablet.

Typically, the department of transportation may need the information regarding the trip such as whether or not the given driver has performed pre trip and post trip inspection, time span when the given driver was driving, when the given driver was on duty and off duty, and the like. Instead of having each driver manually entering the above mentioned trip details, the disclosed system may enable the given driver to indicate a specific event by selecting options 2022, 2024, 2026, 2028, 2030 or 2032.

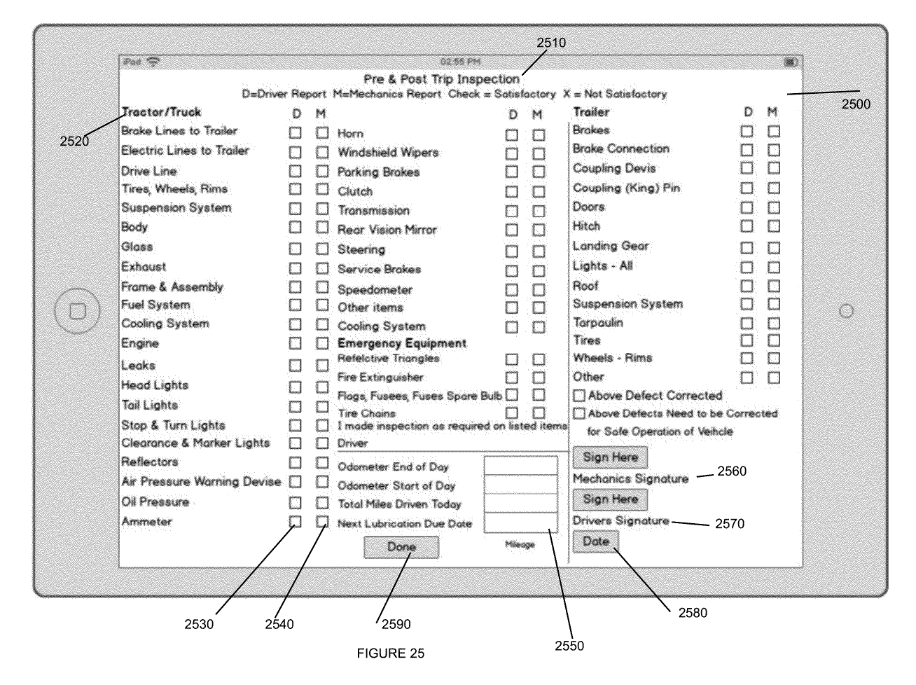

For example, the driver may select options 2022 and 2032 to denote that the driver has completed a pre-trip inspection and post trip inspection respectively. The pre and post trip inspection interface is displayed in FIG. 25. Now discussing FIG. 25, where interface 2500 displays pre and post inspection details 2510. Interface 2500 is an example of a pre & post trip inspection that admins may be able to view on demand. Various parts of equipment that need to be checked as part of pre and post inspection are listed under the heading tractor/truck 2520 such as breaks, horn, engine, oil pressure and the like. The pre-trip inspection may ensure that the equipment is in sound mechanical condition before the equipment departs for a delivery or a pickup assignment. Similarly, post trip the inspection may catch any equipment issues that need to be addressed after the equipment completes given assignment. For each category listed on the interface 2500 the driver may, in the D section indicated by the reference numeral 2530, indicate a positive mark if the listed item is in a sound mechanical condition.

Likewise, the driver may, indicate a check mark in the selection box in D section indicated by the reference numeral 2530, if the listed item in the category is in a sound mechanical condition. Alternatively, if the driver does not indicate a check mark in the selection box indicated by the reference numeral 2530, if it is assumed that the listed item in the category is defective and the item needs either repair or replacement.

Accordingly, for each item with a negative mark in the D section indicated by the reference numeral 2530, a mechanic may fix the item and indicate an item fixed indicator mark in the M section indicated by the reference numeral 2540. In other words, each item listed on the interface 2500 may either have a positive mark in the D section indicated by the reference numeral 2530, or may have a negative mark in the D section indicated by the reference numeral 2530. If a negative mark is indicated in the D section, and the mechanic may fix the defect, and indicate a positive mark in M section indicated by the reference numeral 2540.

The interface 2500 may also indicate odometer information 2550 such as odometer reading at the start and end of the given day, total miles driven on the given day, the day when next lubrication is due, and the like. After performing the pre and post trip inspection, the driver and the mechanic may sign at locations 2570 and 2560 respectively. After indicating the inspection date at location 2580 the driver may conclude the transaction by selecting done option 2590.

Turning back to FIG. 20, the driver may select option 2024 to indicate that the driver is driving. Similarly, the driver may select on duty option 2030 and off duty option 2026 to reflect that the driver is on duty and the driver is off duty respectively. The driver may indicate that the driver was resting by selecting sleeper/berth option 2028. In other words, instead of having the given driver manually note start times of the above mentioned events, the preferred embodiment may advantageously generate an electronic log as shown in FIG. 20. In one embodiment of the disclosed invention, the disclosed system may provide a compliance company an access to the given driver's electronic logs. Thus, the compliance company may, remotely observe and process any infractions in real time. In this embodiment the system may optionally email the electronic logs of the given driver to the compliance company.

Additionally, the log book may contain graphical representation 2012 of driver's activity information within a specific time frame reflecting driver's hours of driving, hours of sleep, hours of on duty but not driving, hours of off duty and the like. Furthermore, time, event, location, and historical or current log indicator 2014 may also be displayed on the interface 2000. After reviewing the information displayed on the interface 2000, the administrator may select option 2016 to edit/rate the driver log, select print option 2020 to print or email the log or select done option 2018 to conclude the driver log review. In one embodiment of the disclosed invention, the system may alert driver and admin when infractions are about to happen, for example, when driver is about to drive past the allowed driving time.

FIG. 21 illustrates locate driver functionality 2102 of the disclosed system. Now turning to FIG. 21, wherein upon selecting the locate driver functionality 2106 of the disclosed system, the administrator may identify precise location of the driver and the equipment. In other words, administrator may view on interface 2100 a map with pins showing the location of each driver, and administrator may also view, by clicking on the pin, the location of the equipment. Furthermore, administrator may see other loads that are situated within a certain distance of the driver's location in real time, these loads can possibly be added to driver's previously scheduled load.

The administrator may click on a pin 2104 displayed on a map which may represent the location of a driver to identify exact location of the driver at a given time. This functionality may be implemented while taking advantage of the global positioning system well known in the art. An interface 2100 may display a map with pins 2104 showing the location of each driver. An administrator may by selecting a specific pin review the precise location of the driver and equipment. This functionality may be implemented by using the global positioning system to identify the location of the given driver's tablet.

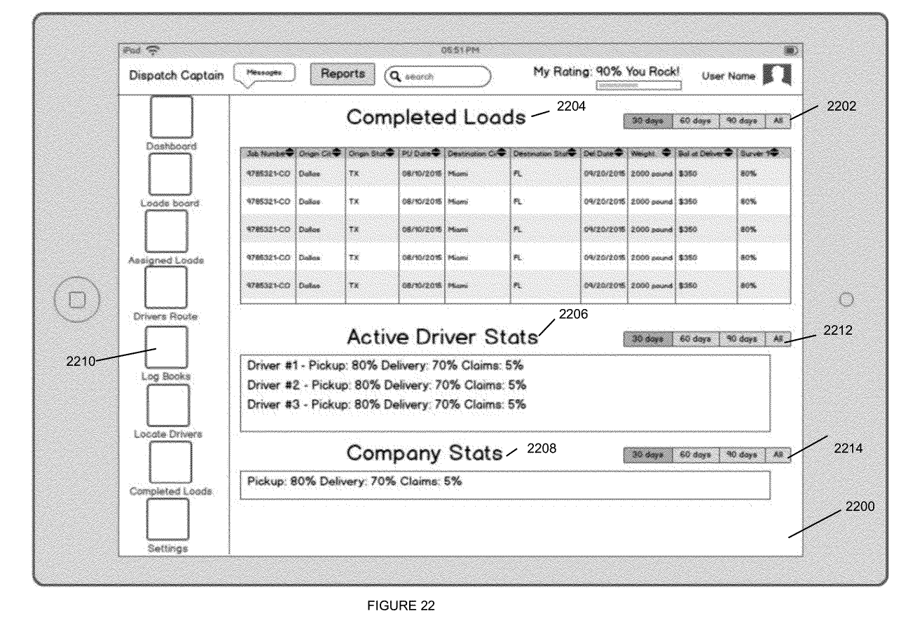

Turning now to FIG. 22 showing completed loads, driver and company statistics information interface 2200 of the system according to the preferred embodiment of the disclosed system. The administrators may, by selecting a log book option 2210, view a list of current or past logs for each driver. For example, by selecting the completed loads option 2204 for a selected amount of time 2202, such as past 30 days, 60 days, 90 days or all the days the driver has been working with the disclosed system, the administrator may view all workloads that have been completed by a particular driver. Administrator may be able to retrieve documents pertaining to the completed jobs using the disclosed system. Likewise, by selecting an active driver statistics option 2206 for a specific driver for a selected amount of time 2212 the administrator may view statistical information as indicated in the survey results for a specific driver such as percentage of timely pickup, timely delivery and claims associated with the drivers via interface 2200.

Similarly, by selecting a company statistics option 2208 for a specific company for a selected amount of time 2222 the administrator may view statistical information as indicated in the survey results for a specific company such as percentage of timely pickup, timely delivery, and claims associated with the company may be displayed on the interface 2200. In other words, the administrator may review statistical information on each driver showing the percentage of picked up loads within the pickup dates, percentage of delivered loads within the delivery dates and claim percentage. A summary of the company may also be available to indicate the overall service level of the company.

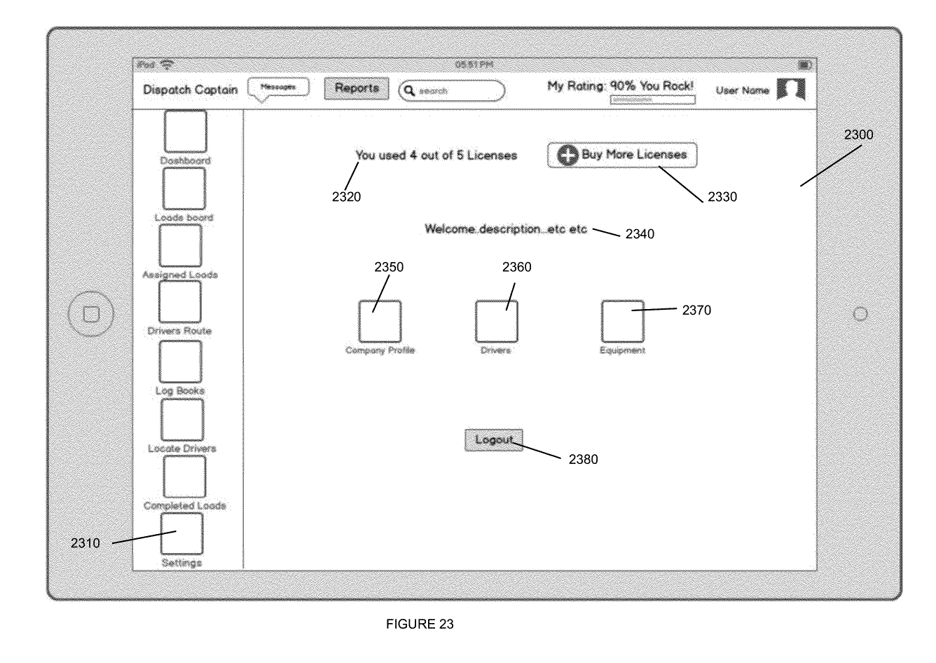

FIG. 23 displays settings interface 2300 displayed upon an administrator selecting the settings option 2310 of the disclosed system, the administrator may change various configuration parameters 2340 displayed on the interface 2300. The setting interface 2300 may give the admin the ability to update the company profile, add or edit drivers and equipment. Administrator may via interface 2300 view the loads that have been completed within 30, 60, 90 or all dates. Administrator may also view statistical data on each driver showing the scores received during the client survey in the categories of pickup and delivery along with claim percentage. A summary of the company performance which may reflect overall service level of the company may also be available for review by the administrator on interface 2300.

Thus, administrator may perform several functions via interface 2300, for example, the administrator may change the company profile by selecting option 2350. Further, the administrator may change driver configuration and equipment configuration by selecting options 2360 and 2370 respectively. The interface 2300 may present an indicator 2320 showing how many licenses were purchased by the company and how many licenses have been used by the company. Additionally, the system may present an option 2330 to purchase more licenses to the administrator. This functionality may be useful when the administrator desires to add a driver or equipment or change company profile information. The administrator may select an option 2380 to conclude setting configuration after saving configuration changes performed via the interface 2300. Thus, administrator may via interface 2300, purchase more licenses, access and edit the company profile, driver configuration and equipment configuration.

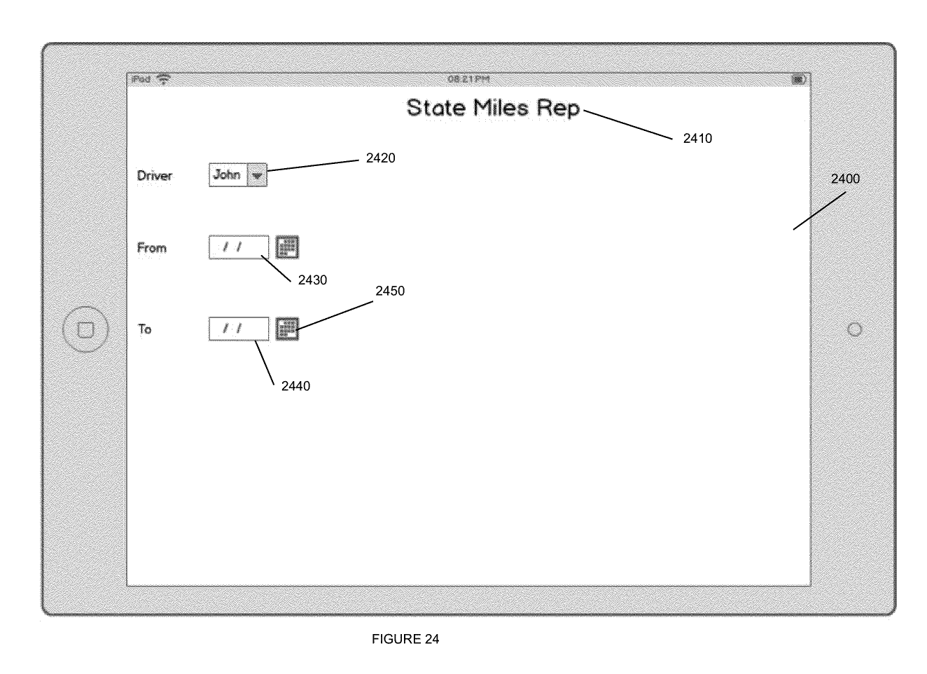

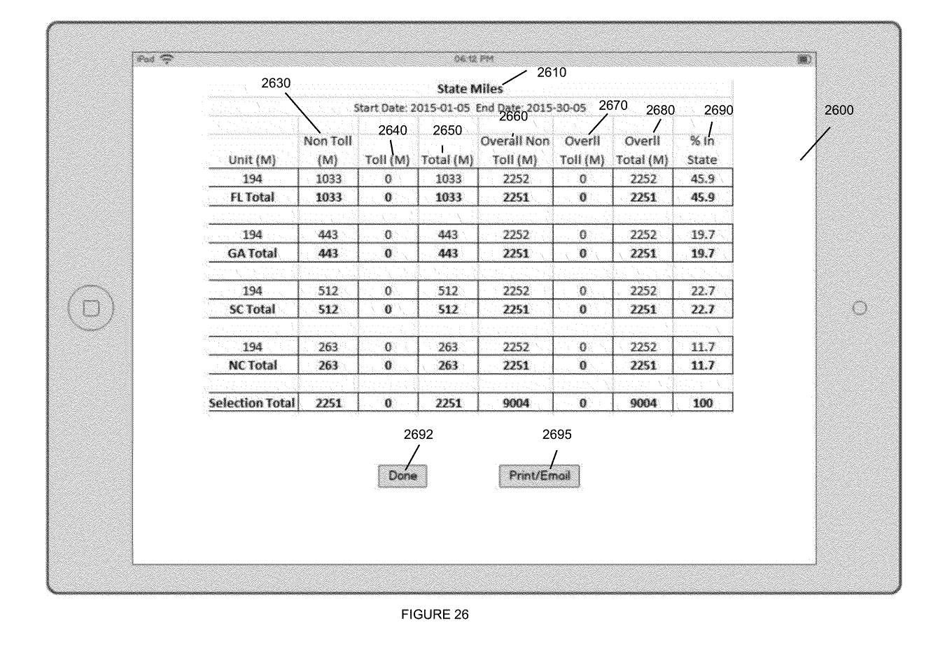

Referring now to FIG. 24 displays an example of the report interface 2400 whereby admin may select a driver and a date range to generate a report for the selected driver's activity during the selected date range according to one embodiment of the disclosed invention. The administrator may generate the report 2410 on interface 2400 shown in FIG. 24. The administrator may select a name from a list of drivers from the drop down list 2420, and a start date 2430 and end date 2440 to generate a report. The administrator may use a calendar utility 2450 for selecting a report start date and a report end date. Interface 2600 shown in FIG. 26 shows an example of the state miles report generated upon the administrator requesting a report for a driver with start date 1/5/2015 and end date 30/5/2015.

As shown in FIG. 26, the state miles report 2610 on the interface 2600 may show the following information for each state traveled by the selected driver during the selected time span 2620: non-toll miles 2630, toll miles 2640, total miles driven in the given state 2650, overall non-toll miles 2660, overall toll miles 2670, overall total miles driven 2680, and percentage of miles driven in the given state 2690. The administrator may select to print and/or email the state miles report by selecting option 2695 before exiting the state miles report interface 2600 by selecting done option 2692. Notably, report functionality of the disclosed system may give administrator the ability to select a driver and run a report based on certain date ranges. Additionally, report may show the miles driven in a specific state over a certain time frame.

Additionally, administrator may also generate a material report or a box report for a selected driver during a selected time span. The box report may reflect the number of boxes and type of boxes that each job assigned to the selected driver and scheduled during the selected time span may require. Accordingly, the administrator can make sure that each driver has the correct material needed for the jobs that are assigned to the selected driver and that are scheduled during the selected time span. This feature may be useful in transporting goods that need special packing materials.

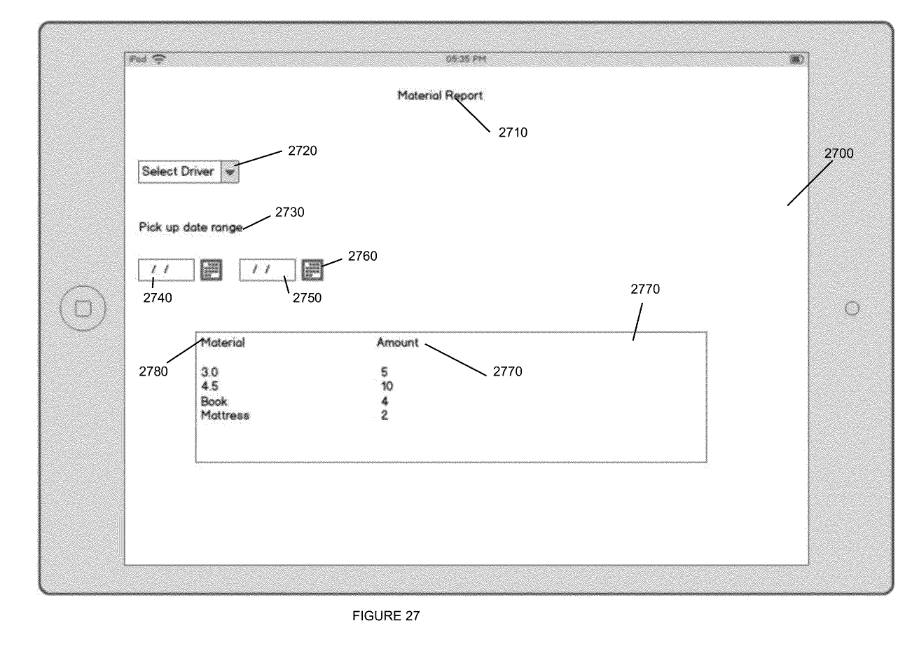

As seen in FIG. 27, material report interface 2700 may display material report 2710 which may show a driver drop down list 2720. The administrator may select a driver's name from the drop down list 2720 and proceed to select a date range. Interface 2700 may present a query pick up date range 2730, in response the administrator may select a start date 2740 and end date 2750 for generating the material report. Optionally, the administrator may use calendar utility 2760 to select the date range. Upon receiving the driver and date range selection, the system may display interface 2770 indicating material 2780, which may need a specified quantity of boxes indicated by amount 2790. This information may be useful for both administrator and the driver to plan and effectively execute the scheduled move in a seamless manner.

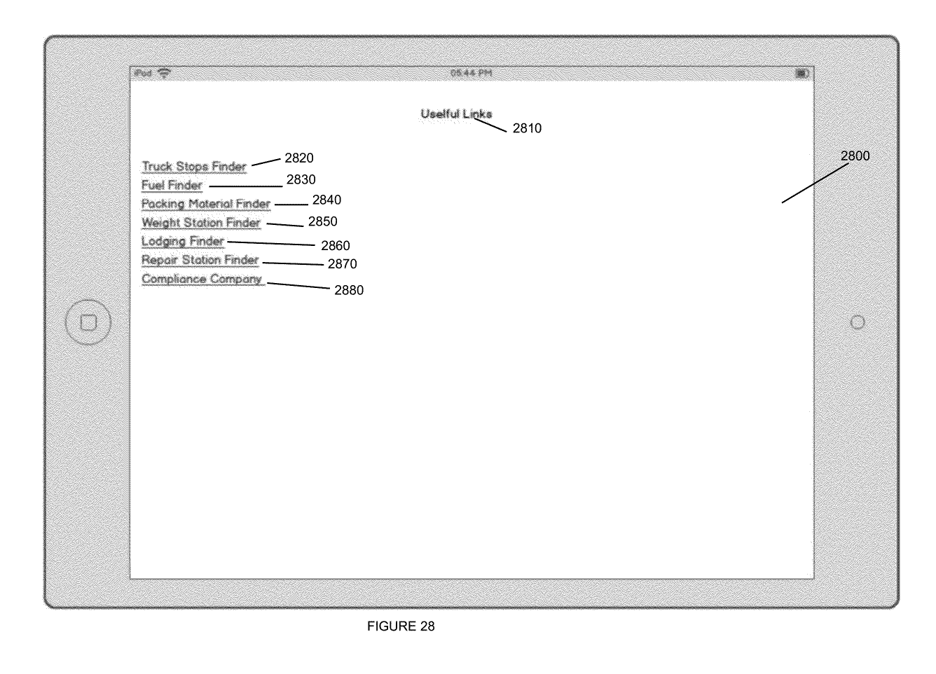

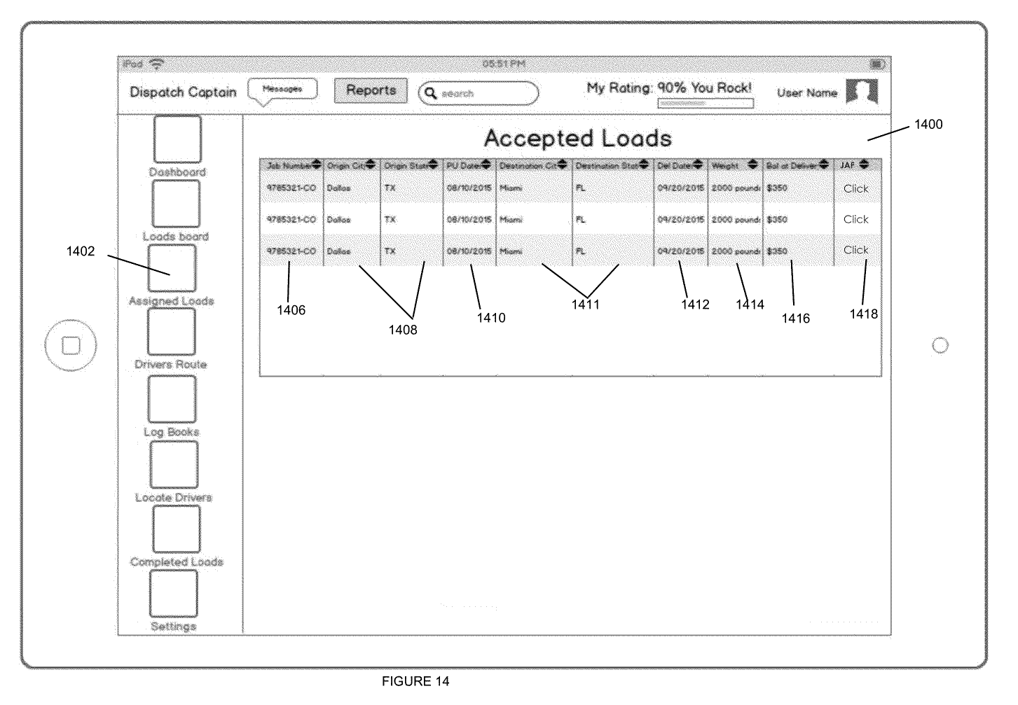

Interface 2800 displaying useful links 2810 is shown in FIG. 28. Several links to applications and websites may be displayed on interface 2800 that may be helpful during the day to day transportation operations. For example, the link truck stop finder 2820 may help a driver in locating a truck stop that is situated closest to the driver's current location. Fuel finder link 2830 may provide a list of gas stations closest to driver's current location. Similarly, material finder link 2840 may identify for the driver the closest warehouse to locate packing material supplier. Weigh station finder link 2850 may help in finding the closest weighing scale to the driver's current location.

Likewise lodging finder link 2860 may provide a list of lodging facilities closest to the driver's current location. In an event if the driver's equipment malfunctions, repair station link 2870 may assist the driver by providing a list of over the road repair stations closest to the driver's current location. Furthermore, compliance company link 2880 may provide a communication link between the driver and the compliance company with whom the driver's company is enrolled with, so that the driver can resolve any compliance issues by asking questions to the compliance company or when requested by the compliance company, the driver may send the requested documents to the compliance company.

The foregoing discussion of the preferred embodiments has been provided only by way of introduction. Nothing in this section should be taken as a limitation of the claims, which define the scope of the invention.

1. A method for dynamically managing transport of at least one item from a source location to a destination location, the method comprising:
ascertaining a mode of an administrator after authenticating the administrator;
performing a set of administrative functions wherein the administrator selected an administrative mode, the set of administrative functions comprising:
viewing a set of loads board, a set of accepted loads, a set of loads situated in vicinity of a driver, a system alert, and a conversation;
assigning a load from the set of accepted loads to the driver and transmitting the assignment notification to drivers;
ascertaining a set of load attributes for loads requested from a set of external sources;
assigning at least one driver to a specific load after reviewing a set of accepted loads and loads assigned to each driver;
viewing the driver's log book for editing at least one of the driver's current log and the driver's past logs;
locating the driver and the driver's equipment on a map by selecting a location indicator on the map;
evaluating the driver's performance by viewing a set of assignments completed by the driver within a specific time span; and
configuring a set of system parameters and generating reports reflecting system performance during a selected time span.

2. The method of claim 1, wherein, the set of system parameters comprise a number of licenses granted to the driver's employer company, a number of licenses granted to the driver, a set of company profile parameters for the company, and a set of equipment assigned to the driver.

3. The method of claim 1, wherein the set of load attributes comprise a load number, a source location city, a source location state, a source location zip, a destination city location, a destination state location, a destination location zip, a pick up date, a delivery date, a load weight measure, the distance measure between the source location and the destination location, and a load cash on delivery details.

4. The method of claim 3, further comprising the step of sorting the requested loads based on at least one of the set of load attributes.

5. The method of claim 1, further comprising the step of changing a load assignment from a first driver to a second driver.

6. The method of claim 1, further comprising the step of accessing a log book of a selected driver during certain time span to perform at least one of: editing the log book, using a past log book to show a historical trend for audit purposes, ascertaining the impact of a specific trip during a specific time span, and sending log book to a third party compliance observing entity.

7. The method of claim 6, further comprising the step of dynamically scheduling an additional load pickup for the selected driver, wherein the additional load is to be picked up at the location that is en route to the selected driver's previously scheduled assignment location.

8. The method of claim 6, further comprising the step of dynamically scheduling an additional load delivery for the selected driver, wherein the additional load is to be delivered at a location that is en route to the selected driver's previously scheduled assignment location.

9. The method of claim 6, further comprising the step of dynamically scheduling a partial load delivery for the selected driver, wherein the partial load is to be delivered at a location that is en route to the selected driver's previously scheduled assignment location.

10. The method of claim 6, further comprising the step of dynamically adding cargo from a malfunctioning equipment located at a first location to the equipment of the selected driver, wherein the first location is en route to the selected driver's previously scheduled assignment location.

11. The method of claim 6, further comprising the step of evaluating the performance of the selected driver by interpreting the statistical information associated with the selected driver, wherein the statistical information comprise a survey score and a claim percentage score of the selected driver.

12. The method of claim 11, further comprising the step of evaluating the performance of a driver by viewing the details pertaining to a set of assignments completed by the driver within a predefined time span.

13. The method of claim 12, wherein the predefined time span is at least one of: 30 days, 60 days, and 90 days.

14. The method of claim 14, wherein the predefined time span is the entire duration of the driver's service at a company.

15. The method of claim 1, further comprising the step of evaluating a company performance by viewing a set of assignments completed by the company within a predefined time span.

16. The method of claim 1, further comprising the step of performing a set of driver functions by a driver wherein the mode is a driver mode, the set of driver functions comprising:
viewing a dashboard displaying a list of loads assigned to the driver, a log book, weather information in the driver's location area, the driver's statistical information, and a set of useful links;
viewing a list of incomplete loads before selecting a job for viewing the load specific information;
viewing a job acceptance form to ascertain a set of job attributes comprising: a job number, a job source location, a job destination location, a packing instruction, a storage instruction, an inventory information, and a special handling instruction;
acknowledging a new job assigned to the driver;
accepting a selected job via the job acceptance form before getting directions to the selected job destination location and commencing paper work for the selected job;
revising the original cost estimation after reviewing at least one of: a move estimation as computed at time of booking, a furniture list, an additional charge, an additional service required during the pickup, an additional service required during the delivery, and the packing instruction;
creating an inventory indicating a list of items to be moved from the source location to the destination location by taking a picture of the actual item and describing a condition of the item;
accepting a payment upon transmitting the inventory from the source location to the destination location;
creating an item damage claim if an item is damaged during the transportation; and
creating a missing item claim if the item is lost during the transportation.

17. The method of claim 16, further comprising the step of the driver performing at least one post contract service at the time of delivery, wherein the post contract service was not accounted for at the pickup time.

18. The method of claim 17, wherein the set of job attributes further comprise a pickup address, a delivery address, a move initiating entity contact information, an estimated weight, a pickup date, a delivery date, and the distance between the pickup location and delivery location.

19. A system for dynamically managing transport of at least one item from a source location to a destination location, the system configured to:
ascertain a mode of the administrator after authenticating an administrator;
perform a set of administrative functions wherein the administrator selected an administrative mode, wherein via the set of administrative functions the system is configured to:
display a loads board, a set of accepted loads, a set of loads situated in vicinity of a driver, a system alert, and a conversation;
assign a load from the set of accepted loads to the driver and transmit the assignment notification to other drivers;
ascertain a set of load attributes for loads requested from a set of external sources;
display a job acceptance form to ascertain a set of job attributes comprising: a job number, an origin location information, a destination location information, a packing instruction, a storage instruction, an inventory information, and a special handling instruction;
assign at least one driver to a specific load after reviewing a set of accepted loads and loads assigned to each driver;
display the driver's log book for editing at least one of the driver's current log and the driver's past logs;
locate the driver and the driver's specific equipment on a map by selecting a location indicator on the map;
evaluate the driver's performance by reviewing a set of assignments completed by the driver within a predefined time span; and
configure a set of system parameters and generating reports reflecting system performance during a selected time span.

20. The system of claim 19, wherein, the set of system parameters comprise a number of licenses granted to the driver's employer company, a number of licenses granted to the driver, a set of company profile parameters for the company, and a set of equipment assigned to the driver.

21. The system of claim 19, wherein the set of load attributes comprise a load number, a source location city, a source location state, a source location zip, a destination city location, a destination state location, a destination location zip, a pick up date, a delivery date, a load weight measure, the distance measure between the source location and the destination location, and a load cash on delivery details.

22. The system of claim 21, further configured to display the set of load attributes after sorting the requested loads based on at least one of the set of load attributes.

23. The system of claim 19, further configured to change a load assignment from a first driver to a second driver.

24. The system of claim 19, further configured to access a log book of a selected driver during certain time span to perform at least one of: edit the log book, use a past log book to show a historical trend for audit purposes, ascertain the impact of a specific trip during a specific time span, and send log book to a third party compliance observing entity.

25. The system of claim 24, further configured to dynamically schedule an additional load pickup for the selected driver, wherein the additional load is to be picked up at the location that is en route to the selected driver's previously scheduled assignment location.

26. The system of claim 24, further configured to dynamically schedule an additional load delivery for the selected driver, wherein the additional load is to be delivered at a location that is en route to the selected driver's previously scheduled assignment location.

27. The system of claim 24, further configured to dynamically schedule a partial load delivery for the selected driver, wherein the partial load is to be delivered at a location that is en route to the selected driver's previously scheduled assignment location.

28. The system of claim 24, further configured to dynamically add cargo from a malfunctioning equipment located at a first location to the equipment of the selected driver, wherein the first location is en route to the selected driver's previously scheduled assignment location.

29. The system of claim 24, further configured to evaluate the performance of the selected driver by interpreting the statistical information associated with the selected driver, wherein the statistical information comprise: a survey score and a claim percentage score of the selected driver.

30. The system of claim 29, further configured to evaluate the performance of a driver by reviewing the details pertaining to a set of assignments completed by the driver within a predefined time span.

31. The system of claim 30, wherein the predefined time span is at least one of: 30 days, 60 days, and 90 days.

32. The system of claim 24, wherein the predefined time span is the entire duration of the driver's service at a company.

33. The system of claim 24, further configured to evaluate a company performance by reviewing a set of assignments completed by the company within a predefined time span.
